(19) United States
(12) Patent Application Publication
(10) Pub. No.: US 2026/0007976 A1
(43) Pub. Date: Jan. 8, 2026

(54) VIRTUAL COMPONENT CONFIGURATION

(71) Applicant: TENCENT TECHNOLOGY (SHENZHEN) COMPANY LIMITED, Shenzhen (CN)

(72) Inventors: Qiao LI, Shenzhen (CN); Keer ZHU, Shenzhen (CN); Bing LIU, Shenzhen (CN)

(73) Assignee: TENCENT TECHNOLOGY (SHENZHEN) COMPANY LIMITED, Shenzhen, GD (CN)

(21) Appl. No.: 19/326,024

(22) Filed: Sep. 11, 2025

Related U.S. Application Data
(63) Continuation of application No. PCT/CN2024/104267, filed on Jul. 8, 2024.

(30) Foreign Application Priority Data
Sep. 4, 2023 (CN) 202311138932.8

(51) Int. Cl. A63F 13/77; A63F 13/42; A63F 13/533

(52) U.S. Cl. CPC A63F 13/77; A63F 13/42; A63F 13/533

(57) ABSTRACT

Some aspects of the disclosure provide a method of virtual component configuration. In some examples, a virtual component in a virtual scene is displayed. A selection operation on the virtual component is received. In response to the selection operation, one or more adjustment controls of the virtual component are displayed based on a component position of the virtual component in the virtual scene, the one or more adjustment controls are displayed with an accompanying association relationship with the virtual component, the accompanying association relationship causes the displaying of the one or more adjustment controls to change with a change in the component position of the virtual component, and the one or more adjustment controls are used to adjust a display status of the virtual component in the virtual scene. Apparatus and non-transitory computer-readable storage medium counterpart embodiments are also contemplated.

### RELATED APPLICATIONS

The present application is a continuation of International Application No. PCT/CN2024/104267, filed on Jul. 8, 2024, which claims priority to Chinese Patent Application No. 202311138932.8, filed on Sep. 4, 2023. The entire disclosures of the prior applications are hereby incorporated by reference.

### FIELD OF THE TECHNOLOGY

Embodiments of this application relate to the field of animation generation technologies, including a virtual component configuration method and apparatus, a device, a medium, and a program product.

### BACKGROUND OF THE DISCLOSURE

With the improvement of cultural and entertainment living standards, people have increasingly higher life experience and requirements on virtual scenes. As an expression manner of the virtual scenes, games become a channel for many people to release stress. In a current game application, a player performs a more interesting game process among game processes by using a virtual prop.

In a related technology, a virtual scene includes various virtual components, and the player sometimes has a requirement on adjusting the virtual component, for example, adjusting a position and a size of the virtual component. A function control for implementing a corresponding adjustment function is usually displayed at a position in an interface, so that the corresponding adjustment function is implemented based on a trigger operation performed by the player on the function control.

In the foregoing process, the function control is usually located at a fixed position in the interface. In an operation process in which the player adjusts the virtual component by using the function control, the player needs to frequently switch attention between the position of the virtual component and the position of the function control. Not only efficiency of adjusting the virtual component is relatively low, but also a precise adjustment of the virtual component by the player is not facilitated, thereby affecting human-computer interaction efficiency.

### SUMMARY

Embodiments of this disclosure provide a virtual component configuration method and apparatus, a device, a medium, and a program product. Technical solutions provided in embodiments of this disclosure are as follows.

Some aspects of the disclosure provide a method of virtual component configuration. In some examples, a virtual component in a virtual scene is displayed. A selection operation on the virtual component is received. In response to the selection operation, one or more adjustment controls of the virtual component are displayed based on a component position of the virtual component in the virtual scene, the one or more adjustment controls are displayed with an accompanying association relationship with the virtual component, the accompanying association relationship causes the displaying of the one or more adjustment controls to change with a change in the component position of the virtual component, and the one or more adjustment controls are used to adjust a display status of the virtual component in the virtual scene.

Some aspects of the disclosure provide an information processing apparatus that includes processing circuitry configured to perform the method of virtual component configuration.

Some aspects of the disclosure also provide a non-transitory computer-readable storage medium storing instructions which when executed by at least one processor cause the at least one processor to perform the method of virtual component configuration.

According to an aspect, a virtual component configuration method is provided, the method being performed by a terminal device, and the method including: displaying a virtual component, the virtual component being a component element located in a virtual scene; receiving a selection operation on the virtual component; and displaying, based on a component position of the virtual component in the virtual scene in response to the selection operation, at least one adjustment control having an accompanying association relationship with the virtual component, the accompanying association relationship being configured for representing a relationship in which the at least one adjustment control changes with a change in the component position, and the adjustment control being configured for adjusting a display status of the virtual component in the virtual scene.

According to another aspect, a virtual component configuration apparatus is provided, the apparatus including: a display module, configured to display a virtual component, the virtual component being a component element located in a virtual scene; and a receiving module, configured to receive a selection operation on the virtual component, the display module being further configured to display, based on a component position of the virtual component in the virtual scene in response to the selection operation, at least one adjustment control having an accompanying association relationship with the virtual component, the accompanying association relationship being configured for representing a relationship in which the at least one adjustment control changes with a change in the component position, and the adjustment control being configured for adjusting a display status of the virtual component in the virtual scene.

According to another aspect, a computer device is provided, the computer device including a processor (an example of processing circuitry) and a memory, the memory having a computer program stored therein, the computer program being loaded and executed by the processor to implement the foregoing virtual component configuration method.

According to another aspect, a computer-readable storage medium (e.g., non-transitory computer-readable storage medium) is provided, the storage medium having a computer program stored therein, the computer program being loaded and executed by a processor to implement the foregoing virtual component configuration method.

According to another aspect, a computer program product is provided, the computer program product including a computer program, and the computer program is stored in a computer-readable storage medium. A processor of a computer device reads the computer program from the computer-readable storage medium and executes the computer program, to cause the computer device to perform the foregoing virtual component configuration method.

The technical solutions provided in embodiments of this disclosure produce at least the following beneficial effects.

After the selection operation on the virtual component is received, the at least one adjustment control having the accompanying association relationship with the virtual component is displayed based on the component position of the virtual component in the virtual scene. The accompanying association relationship is configured for representing the relationship in which the at least one adjustment control changes with a change in the component position. Therefore, a position at which the at least one adjustment control is displayed is closer to the component position of the virtual component. This is beneficial for a player to view the adjustment control during observation of the virtual component. In addition, the adjustment control is configured for adjusting the display status of the virtual component in the virtual scene. Therefore, a process of adjusting the virtual component more efficiently can be implemented by using the at least one adjustment control that is displayed more closely to the virtual component, thereby avoiding a problem of relatively low adjustment efficiency caused by fixedly displaying the adjustment control in the virtual scene, and improving human-computer interaction efficiency by virtue of a display effect of the accompanying association relationship.

### BRIEF DESCRIPTION OF THE DRAWINGS

FIG. 1 is a block diagram of a structure of an electronic device according to an embodiment of this disclosure.

FIG. 2 is a block diagram of a structure of a computer system according to an embodiment of this disclosure.

FIG. 3 is a flowchart of a virtual component configuration method according to an embodiment of this disclosure.

FIG. 4 is a flowchart of a virtual component configuration method according to another embodiment of this disclosure.

FIG. 5 is a schematic diagram of an interface of a virtual scene according to an embodiment of this disclosure.

FIG. 6 is a schematic diagram of an interface for displaying at least one adjustment control having an accompanying association relationship with a virtual component according to an embodiment of this disclosure.

FIG. 7 is a schematic diagram of an interface for moving a virtual component by using a movement control according to an embodiment of this disclosure.

FIG. 8 is a schematic diagram of an interface for adjusting a component size of a virtual component by using a size adjustment control according to an embodiment of this disclosure.

FIG. 9 is a schematic diagram of an interface for adjusting a rotation angle of a virtual component by using an angle adjustment control according to an embodiment of this disclosure.

FIG. 10 is a flowchart of a virtual component configuration method according to still another embodiment of this disclosure.

FIG. 11 is a schematic diagram of an interface for moving a virtual component and a component adjustment region according to an embodiment of this disclosure.

FIG. 12 is a schematic diagram of an interface for adjusting a component size of a virtual component and a region size of a component adjustment region according to an embodiment of this disclosure.

FIG. 13 is a flowchart of a virtual component configuration method according to yet another embodiment of this disclosure.

FIG. 14 is a schematic diagram of an interface of a virtual scene according to an embodiment of this disclosure.

FIG. 15 is a schematic diagram of an interface for displaying a component coordinate system according to an embodiment of this disclosure.

FIG. 16 is a schematic diagram of an interface of a related technology according to an embodiment of this disclosure.

FIG. 17 is a schematic diagram of an interface for moving a virtual component to a second position according to an embodiment of this disclosure.

FIG. 18 is a schematic layer diagram of displaying a virtual component after movement according to an embodiment of this disclosure.

FIG. 19 is a flowchart of a virtual component configuration method according to another embodiment of this disclosure.

FIG. 20 is a block diagram of a structure of a virtual component configuration apparatus according to an embodiment of this disclosure.

FIG. 21 is a block diagram of a structure of a terminal according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Virtual scene can refer to a virtual scene displayed (provided) when an application program runs on a terminal. The virtual scene may be a simulated scene of a real scene, may be a semi-simulated and semi-fictional scene, or may be a completely fictional scene. The virtual scene may be any one of a two-dimensional virtual scene, a 2.5-dimensional virtual scene, and a three-dimensional virtual scene. This is not limited in this disclosure. The following embodiments are described by using an example in which the virtual scene is a three-dimensional virtual scene.

Virtual model can refer to a model configured for imitating a real scene in the virtual scene. For example, the virtual model occupies a volume in the virtual scene. For example, the virtual model includes: a terrain model, a building model, an animal and plant model, a virtual prop model, a virtual carrier model, and a virtual object model. For example, the terrain model includes: a ground surface, a mountain, a water stream, a stone, and a step. The building model includes: a house, a wall, a container, and a fixed facility inside a building: a table, a chair, a cabinet, a bed, or the like. The animal and plant model includes: a tree, a flower, grass, a bird, and the like. The virtual prop model includes: a virtual attack prop, a medicine box, an air-drop, and the like. The virtual carrier model includes: an automobile, a ship, a helicopter, and the like. The virtual object model includes: a character, an animal, an animation character, and the like.

Virtual role/virtual object can refer to a movable object in the virtual scene. The movable object may be a virtual object, a virtual animal, an animation character, or the like, such as a character, an animal, a plant, an oil barrel, a wall, or a stone displayed in the three-dimensional virtual scene. In one embodiment, the virtual object is a three-dimensional model created based on a skeletal animation technology. Each virtual object has a shape and a volume in the three-dimensional virtual scene, and occupies some space in the three-dimensional virtual scene.

In a related technology, a virtual scene includes various virtual components, and a player sometimes has a requirement on adjusting the virtual component, for example: adjusting a position and a size of the virtual component. A function control for implementing a corresponding adjustment function is usually displayed at a position in an interface, so that the corresponding adjustment function is implemented based on a trigger operation performed by the player on the function control. In the foregoing process, the function control is usually located at a fixed position in the interface. In an adjustment process in which the player adjusts the virtual component by using the function control, the player needs to frequently switch attention between the position of the virtual component and the position of the function control. Not only efficiency of adjusting the virtual component is relatively low, but also a precise adjustment of the virtual component by the player is not facilitated, thereby affecting human-computer interaction efficiency.

In an embodiment of this disclosure, a virtual component configuration method is provided. A virtual component and at least one adjustment control are displayed more closely by means of an accompanying association relationship. This is beneficial for a player to view and trigger an adjustment control more efficiently during observation of the virtual component, thereby avoiding a problem of relatively low adjustment efficiency caused by fixedly displaying the adjustment control in a virtual scene, and improving human-computer interaction efficiency. For the virtual component configuration method in this disclosure, at least one of a plurality of virtual scenes such as a virtual shooting scene and a virtual battle scene is included during an application. The foregoing application scenes are merely examples, and the virtual component configuration method provided in this embodiment may alternatively be applied to another scene. This is not limited in embodiments of this disclosure.

In this disclosure, a prompt interface or a pop-up window may be displayed, or voice prompt information may be outputted before collecting user-related data and during collection of the user-related data. The prompt interface, the pop-up window, or the voice prompt information is configured for prompting a user that the user-related data is currently being collected. In this way, in this disclosure, related operations of obtaining the user-related data only start to be performed after a confirmation operation of the user performed on the prompt interface or the pop-up window; otherwise (that is, when the confirmation operation of the user performed on the prompt interface or the pop-up window is not obtained), the related operations of obtaining the user-related data are ended, that is, the user-related data is not obtained. In other words, all user data collected in this disclosure is collected with user consent and authorization, and collection, use, and processing of the user-related data need to comply with relevant laws, regulations, and standards of relevant regions.

A terminal in this disclosure may be a desktop computer, a laptop computer, a mobile phone, a tablet computer, an e-book reader, a moving picture experts group audio layer III (MP3) player, a moving picture experts group audio layer IV (MP4) player, or the like. An application program supporting a virtual environment, for example, an application program supporting a three-dimensional virtual environment, is installed and run on the terminal. The application program may be any one of a virtual reality application program, a three-dimensional map program, a third-person shooting (TPS) game, a first-person shooting (FPS) game, a multiplayer online battle arena (MOBA) game, and the like. In one embodiment, the application program may be a standalone application program, for example, a standalone three-dimensional game program; or may be a network-connected application program.

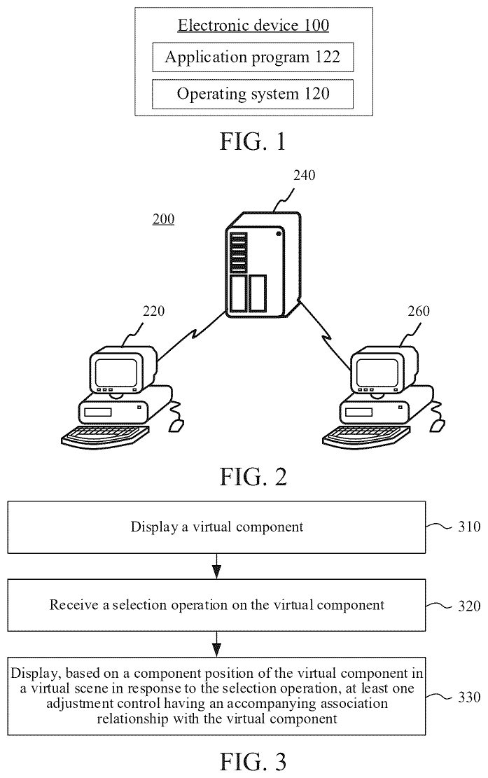

FIG. 1 is a block diagram of a structure of an electronic device according to an embodiment of this disclosure. The electronic device 100 includes an operating system 120 and an application program 122.

The operating system 120 is basic software provided for the application program 122 to perform secure access to computer hardware.

The application program 122 is an application program supporting a virtual environment. In one embodiment, the application program 122 is an application program supporting a three-dimensional virtual environment. The application program 122 may be any one of a virtual reality application program, a three-dimensional map program, a TPS game, an FPS game, a MOBA game, and a multi-player shootout survival game. The application program 122 may be a standalone application program, for example, a standalone three-dimensional game program; or may be a network-connected application program.

FIG. 2 is a block diagram of a structure of a computer system according to an embodiment of this disclosure. The computer system 200 includes a first device 220, a server 240, and a second device 260.

An application program supporting a virtual environment is installed and run on the first device 220. The application program may be any one of a virtual reality application program, a three-dimensional map program, a TPS game, an FPS game, a MOBA game, and a multi-player shootout survival game. The first device 220 is a device used by a first user. The first user uses the first device 220 to control a first virtual object in the virtual environment to perform an action. The action includes, but is not limited to, at least one of a body posture adjustment, crawling, walking, running, cycling, jumping, driving, picking, shooting, attacking, and throwing. In some aspects, the first virtual object is a first virtual character, such as a simulated character role or an animation character role.

The first device 220 is connected to the server 240 through a wireless network or a wired network.

The server 240 includes at least one of one server, a plurality of servers, a cloud computing platform, and a virtualization center. The server 240 is configured to provide a background service for an application program supporting a three-dimensional virtual environment. In one embodiment, the server 240 is responsible for primary computing work, and the first device 220 and the second device 260 are responsible for secondary computing work. Alternatively, the server 240 is responsible for secondary computing work, and the first device 220 and the second device 260 are responsible for primary computing work. Alternatively, the server 240, the first device 220, and the second device 260 perform collaborative computing by using a distributed computing architecture among each other.

An application program supporting a virtual environment is installed and run on the second device 260. The application program may be any one of a virtual reality application program, a three-dimensional map program, an FPS game, a MOBA game, and a multi-player shootout survival game. The second device 260 is a device used by a second user. The second user uses the second device 260 to control a second virtual object in the virtual environment to perform an action. The action includes, but is not limited to, at least one of a body posture adjustment, crawling, walking, running, cycling, jumping, driving, picking, shooting, attacking, and throwing. In some aspects, the second virtual object is a second virtual character, such as a simulated character role or an animation character role.

In one embodiment, the first virtual character and the second virtual character are located in the same virtual environment. In one embodiment, the first virtual character and the second virtual character may belong to the same team or the same organization, have a friend relationship, or have a temporary communication permission. In one embodiment, the first virtual character and the second virtual character may alternatively belong to different teams, different organizations, or two groups hostile to each other.

In one embodiment, the application programs installed on the first device 220 and the second device 260 are the same, or the application programs installed on the two devices are the same type of application programs on different control system platforms. The first device 220 may generally refer to one of a plurality of devices, and the second device 260 may generally refer to one of a plurality of devices. This embodiment is described by using only the first device 220 and the second device 260 as examples. Device types of the first device 220 and the second device 260 are the same or different. The device types include: at least one of a game console, a desktop computer, a smartphone, a tablet computer, an e-book reader, an MP3 player, an MP4 player, and a laptop portable computer. The following embodiments are described by using an example in which the device is a desktop computer.

It is noted that there may be more or fewer devices. For example, there may be only one device, or there may be dozens of or hundreds of or more devices. A quantity of devices and the device type are not limited in embodiments of this disclosure.

The server 240 may be implemented as a physical server, or may be implemented as a cloud server in a cloud. A cloud technology is a hosting technology that unifies a series of resources such as hardware, software, and networks in a wide area network or a local area network to implement computing, storage, processing, and sharing of data. The cloud technology is a general term for a network technology, an information technology, an integration technology, a management platform technology, an application technology, and the like that are applied based on a cloud computing business model. The technologies can form a resource pool to be flexibly used on demand.

In some embodiments, a method provided in embodiments of this disclosure may be applied to a cloud game scene, so that the cloud server completes computing of data logic in a game process, and a terminal is responsible for displaying a game interface.

In some embodiments, the server 240 may alternatively be implemented as a node in a blockchain system.

The virtual component configuration method provided in this disclosure is described with reference to brief introduction of terms and application scenes described above. Description is provided by using an example in which the method is applied to a terminal device, that is, operations of the method are executed by the terminal device. As shown in FIG. 3, the method includes the following operations 310 to 330.

Operation 310: Display a virtual component.

The virtual component is a component element located in a virtual scene. In one embodiment, the virtual component is implemented as various objects existing in the virtual scene, such as a virtual prop, a virtual building, a virtual vehicle, and a virtual pet.

In some aspects, the virtual scene is a scene corresponding to a role-playing game, and the virtual component is implemented as a virtual costume, virtual equipment, a virtual part, or the like in the role-playing game. Alternatively, the virtual scene is a scene corresponding to a sandbox game, and the virtual component is implemented as a virtual building, a virtual road, a virtual jungle, or the like in the sandbox game. Alternatively, the virtual scene is a scene corresponding to a combat game, and the virtual component is implemented as a virtual combat prop, a virtual first help kit, a virtual cartridge, a virtual bow and arrow, or the like in the combat game.

In some embodiments, the virtual component is a component displayed during display of the virtual scene. In some aspects, when a player enters a game, a virtual scene is displayed, and the virtual scene includes a plurality of virtual components.

In some embodiments, the virtual component is a component generated based on a task completion status. In some aspects, when a player enters a game, a virtual scene is displayed, various game tasks are arranged in the virtual scene, and the player may complete each game task in a manner of participating in the game, to generate a virtual component in the virtual scene based on a task completion status of the game task. For example, a game task A and a game task B are arranged in a virtual scene, and a relatively rare virtual component 1 is generated if the game task A having a relatively high task level is completed; or a virtual component 2 with a relatively low rare degree is generated if the game task B with a relatively low task level is completed.

In some embodiments, the virtual component is a component displayed based on a component trigger operation. The component trigger operation is an operation performed by a user for triggering displaying a virtual component. In some aspects, a virtual scene is displayed when a player enters a game, and a virtual store includes a plurality of component accessories. For example, the plurality of component accessories are displayed in a preset display region of a game interface, a trigger operation of the player on the component accessories is used as a component trigger operation, and a virtual component formed by the component accessories is generated through the trigger operation of the player on the component accessories, such as placement, combination, copying, and stacking.

In an embodiment, the virtual component has shape information, and the shape information is configured for representing a component shape of the virtual component. In some aspects, when the virtual scene is a three-dimensional scene, the virtual component is implemented as various three-dimensional shapes such as a cube shape, a cylinder shape, a half-cylinder shape, a cone shape, a sector shape, a sphere shape, a slide shape, a step shape, and a switch shape, or may be implemented as various two-dimensional plane shapes such as a rectangle, a square, a trapezoid, a triangle, a parallelogram, and a circle. When the virtual scene is a two-dimensional scene, the virtual component may be implemented as various two-dimensional plane shapes such as a rectangle, a square, a trapezoid, a triangle, a parallelogram, and a circle.

In one embodiment, in addition to a preset shape, the component shape of the virtual component may further be implemented based on various shapes combined by preset shapes. That is, the shape information corresponding to the virtual component can represent various regular shapes and irregular shapes of the virtual component.

In some aspects, the preset shape includes a plurality of shapes such as a cube shape, a cylinder shape, a half-cylinder shape, a cone shape, a sector shape, a sphere shape, and a slide shape. The preset shape may be considered as a shape corresponding to the component accessory. At least two of the preset shapes are combined to obtain the virtual component obtained based on the component accessory.

The foregoing descriptions are merely examples, and are not limited in embodiments of this disclosure.

Operation 320: Receive a selection operation on the virtual component.

In some aspects, one or more virtual components are displayed in the virtual scene, and the selection operation is performed on any one of the virtual components.

The selection operation is configured for selecting a virtual component. In one embodiment, the selection operation is implemented as at least one of a plurality of operation manners such as a click/tap operation, a long-press operation, and a voice trigger operation.

In some aspects, an example in which a player performs a selection operation on any virtual component is configured for description, and a click/tap operation performed by the player on the virtual component in the virtual scene is used as a selection operation. Alternatively, a long-press operation performed by the player on the virtual component in the virtual scene is used as a selection operation.

Operation 330: Display, based on a component position of the virtual component in the virtual scene in response to the selection operation, at least one adjustment control having an accompanying association relationship with the virtual component.

The component position is configured for representing position information of the virtual component in the virtual scene.

In one embodiment, the component position is a position determined based on a component center of the virtual component. In some aspects, the component center is a component center of gravity of the virtual component; the component center is a diagonal intersection point of a component geometric body of the virtual component; or the component center is a center point of a component bottom of the virtual component, and the component bottom is a contact surface for placing the virtual component on a virtual ground surface in the virtual scene.

In one embodiment, the component position is position information determined based on a component bounding box corresponding to the virtual component.

In some aspects, the virtual component has meanings in the fields of computer graphics and computing geometry, and the component bounding box is configured for representing a closed space surrounding the virtual component. A complex geometric shape of a virtual component is approximately replaced by using a bounding box shape, to analyze the virtual component more rapidly. A spatial position occupied by the component bounding box in the virtual scene is used as the component position corresponding to the virtual component; a contact region between the component bounding box and the virtual ground surface in the virtual scene is used as the component position corresponding to the virtual component; or the like.

The foregoing descriptions are merely examples, and are not limited in embodiments of this disclosure.

In an embodiment, the at least one adjustment control distributed according to a preset control distribution rule is displayed in a preset region range corresponding to the component position and by using the virtual component as a center. The accompanying association relationship exists between the at least one adjustment control and the virtual component.

In some aspects, a region size and a region shape are predetermined as a region range for displaying the at least one adjustment control. After the component position corresponding to the virtual component is determined, the preset region range corresponding to the virtual component is displayed with reference to the component position and the preset region range.

For example, the preset region range is a circular region having a radius of a, and after the component position corresponding to the virtual component is determined, the preset region range corresponding to the virtual component is determined with reference to the component position and the circular region having the radius of a; or the preset region range is a rectangular region having a diagonal line of b, and after the component position corresponding to the virtual component is determined, the preset region range corresponding to the virtual component is determined with reference to the component position and the rectangular region having the diagonal line of b.

In some aspects, the preset control distribution rule is a preset distribution rule, and is configured for constraining a display status of the at least one adjustment control. For example, a rectangular coordinate system is established by using the virtual component as a center, and the preset control distribution rule represents displaying an adjustment control 1 at position coordinates (1, 1); and displaying an adjustment control 2 at position coordinates (1, 2).

In some embodiments, the accompanying association relationship is configured for representing a relationship in which the at least one adjustment control changes with a change in the component position.

In some aspects, the accompanying association relationship is implemented as at least one of the following cases: (1) the at least one adjustment control changes a position with the virtual component; (2) the at least one adjustment control changes an angle with the virtual component; (3) the at least one adjustment control changes a size with the virtual component; and (4) the at least one adjustment control changes an appearance with the component center of the virtual component, such as a color change or a shape change.

In some embodiments, the adjustment control is configured for adjusting a display status of the virtual component in the virtual scene.

In one embodiment, the display status is configured for representing an effect of presenting the virtual component in the virtual scene. In some aspects, the display status includes at least one of a position display state, an angle display state, a size display state, and an appearance display state.

In some embodiments, different adjustment controls correspond to different adjustment functions, and the adjustment control is triggered to implement an adjustment process of the virtual component by using the adjustment function corresponding to the adjustment control.

In some aspects, the adjustment control 1 corresponds to a position adjustment function, and is configured for adjusting a position of the virtual component in the virtual scene; and the adjustment control 2 corresponds to a size adjustment function, and is configured for adjusting a size of the virtual component in the virtual scene.

In an embodiment, based on a component type of the virtual component, an adjustment control corresponding to the component type is displayed as the at least one adjustment control by using the accompanying association relationship.

In one embodiment, the component type of the virtual component is attribute information of the virtual component, and is information predetermined based on the type of the virtual component.

In some aspects, preset component types are classified into an environment type and a prop type, and a virtual building and a virtual road are classified into the environment type, in other words, component types of the virtual building, the virtual road, and a virtual jungle are the environment type; and a virtual costume and virtual equipment are classified into the prop type, in other words, component types of the virtual costume and the virtual equipment is the prop type.

In some embodiments, adjustment controls respectively corresponding to different component types are preset, and when the at least one adjustment control having the accompanying association relationship with the virtual component is displayed, based on a component type of a selected virtual component, the adjustment control corresponding to the component type is displayed as at least one adjustment control corresponding to the virtual component.

In some aspects, it is preset that adjustment controls corresponding to a component type M (for example, an environment type) includes an adjustment control 1 and an adjustment control 2; and adjustment controls corresponding to a component type N (for example, a prop component) includes an adjustment control 1, an adjustment control 3, and an adjustment control 4. After a player performs a selection operation on virtual equipment n belonging to the component type N, at least one adjustment control among the adjustment control 1, the adjustment control 3, and the adjustment control 4 that correspond to the component type N is displayed as at least one adjustment control corresponding to the virtual equipment n, and the foregoing accompanying association relationship exists between the at least one adjustment control and the virtual component.

The foregoing component types are merely examples. The component types may further include various types such as a building type, a vehicle type, a costume type, a daily necessity type, and a furniture type. Adjustment controls corresponding to different component types may be information configured by default or information configured through user-definition. This is not limited in embodiments of this disclosure.

In the foregoing manner, based on the component type of the virtual component, the adjustment control matching the component type is displayed, so that the displayed adjustment control better meets an adjustment operation requirement of the user on the virtual component, thereby increasing human-computer interaction efficiency.

In some embodiments, in addition to the foregoing component types, the attribute information of the virtual component further includes other various information representing a status of the virtual component.

In some aspects, the attribute information further includes at least one of a plurality of types of information such as shape information, size information, orientation information, appearance information, mass information, motion information, and annotation information of the virtual component.

The shape information is configured for representing a component shape of the virtual component, such as a cube shape, a cylinder shape, a half-cylinder shape, or a cone shape.

The size information is configured for representing a size (or referred to as a magnitude) of the virtual component. For example, the size information is implemented as a component volume, a component perimeter, or an area of a component cross section of the virtual component.

The orientation information is configured for representing an orientation situation of the virtual component in the virtual scene. For example, it is preset that a surface of the virtual component is a front component surface, and the orientation information is configured for representing a direction that the front component surface of the virtual component faces, such as a northeast direction or a southeast direction. In one embodiment, the orientation information may alternatively be determined by using a direction indication bar (including an angle, a direction indication, a positioning identifier, and the like) displayed in the virtual scene. This is not limited herein.

The appearance information is configured for representing an appearance situation of the virtual component in the virtual scene. For example, the appearance information is implemented as a component color, a component skin, or a component grayscale of the virtual component.

The mass information is configured for representing a component mass of the virtual component. For example, each of different virtual components corresponds to one preset weight; or the component mass of the virtual component is determined based on a sum of masses respectively corresponding to the component accessories forming the virtual component.

The motion information is configured for representing information used during motion of the virtual component in the virtual scene. In some aspects, the motion information includes a motion condition, an average motion speed, a motion acceleration, and movable duration.

The annotation information is configured for representing an annotation situation of the virtual component in the virtual scene. For example, the annotation information is attached around the virtual component, to indicate display duration, an obtaining condition, or other related information (for example, any one or more of the foregoing attribute information) of the virtual component. In one embodiment, the annotation information may be implemented as information configured by default, may be implemented as manually added information, or the like.

The foregoing descriptions are merely examples, and are not limited in embodiments of this disclosure.

To sum up, after the selection operation on the virtual component is received, the at least one adjustment control having the accompanying association relationship with the virtual component is displayed based on the component position of the virtual component in the virtual scene. The accompanying association relationship is configured for representing the relationship in which the at least one adjustment control changes with a change in the component position. Therefore, a position at which the at least one adjustment control is displayed is closer to the component position of the virtual component. This is beneficial for the player to view the adjustment control during observation of the virtual component. In addition, the adjustment control is configured for adjusting the display status of the virtual component in the virtual scene. Therefore, a process of adjusting the virtual component more efficiently can be implemented by using the at least one adjustment control that is displayed more closely to the virtual component, thereby avoiding a problem of relatively low adjustment efficiency caused by fixedly displaying the adjustment control in the virtual scene, and improving human-computer interaction efficiency by virtue of a display effect of the accompanying association relationship.

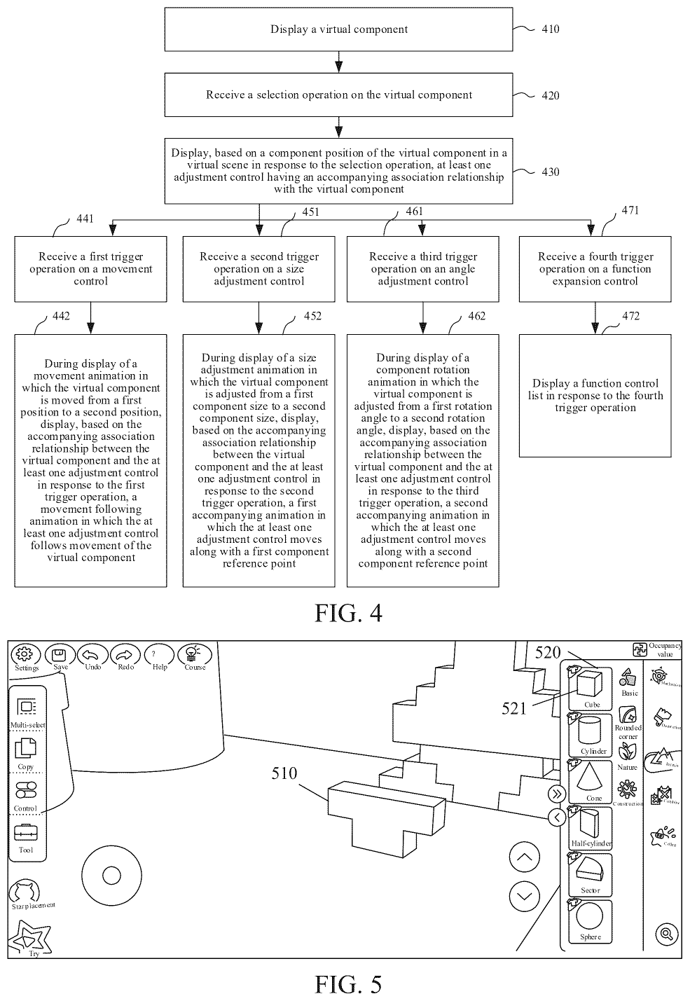

In an embodiment, the at least one adjustment control having the accompanying association relationship with the virtual component is configured for implementing different adjustment functions, so that the display status of the virtual component in the virtual scene is adjusted through a trigger operation on a corresponding adjustment control. In some aspects, as shown in FIG. 4, the embodiment shown in FIG. 3 may alternatively be implemented as operation 410 to operation 472 described below.

Operation 410: Display a virtual component.

The virtual component is a component element located in a virtual scene.

In some aspects, FIG. 5 is a schematic diagram of an interface of a virtual scene, and a virtual component 510 is displayed in the virtual scene. In addition, the virtual scene further includes function controls for implementing different game functions.

In one embodiment, as shown in FIG. 5, the virtual component 510 is a component element formed by combining component accessories of different shapes presented in a shape selection region 520. For example, the virtual component 510 is jointly formed by using one cube 521 and one cuboid in the shape selection region 520 (the shape selection region 520 is not shown); or the virtual component 510 is jointly formed by using a plurality of cubes 521 in the shape selection region 520.

The foregoing virtual scene being implemented as a three-dimensional scene and the virtual component being implemented as a three-dimensional component element are merely examples. Alternatively, the virtual scene may be implemented as a three-dimensional scene and the virtual component may be implemented as a two-dimensional component element. Alternatively, the virtual scene is implemented as a two-dimensional scene, and the virtual component is implemented as a two-dimensional component element. This is not limited in embodiments of this disclosure.

Operation 420: Receive a selection operation on the virtual component.

In one embodiment, the selection operation is implemented as at least one of a plurality of operation manners such as a click/tap operation, a long-press operation, and a voice trigger operation.

In some aspects, as shown in FIG. 5, a click/tap operation by a player on the virtual component 510 is used as the selection operation. Alternatively, a long-press operation by a player on the virtual component 510 is used as the selection operation. For example, when duration for long-pressing the virtual component 510 reaches preset duration of two seconds, it is considered that the selection operation is triggered.

Operation 430: Display, based on a component position of the virtual component in the virtual scene in response to the selection operation, at least one adjustment control having an accompanying association relationship with the virtual component.

The accompanying association relationship is configured for representing a relationship in which the at least one adjustment control changes with a change in the component position, and the adjustment control is configured for adjusting a display status of the virtual component in the virtual scene.

In an embodiment, the at least one adjustment control having the accompanying association relationship with the virtual component is displayed in a preset region range corresponding to the component position.

In one embodiment, the preset region range is a region range determined by combining a preset region shape and a preset region size. For example, the region shape includes at least one of a plurality of shapes such as a circular region, a rectangular region, a triangular region, and an irregular region. The region size is a size specified based on the region shape. For example, the region shape is implemented as a circular region, and a radius corresponding to the circular region is set to determine the region size; or the region shape is implemented as a rectangular region, and a length and a width corresponding to the rectangular region are set to determine the region size.

The at least one adjustment control having the accompanying association relationship with the virtual component is displayed in the preset region range corresponding to the component position, so that a position relationship between the adjustment control for the virtual component and the virtual component is relatively fixed, thereby facilitating memorization by a user.

In some aspects, the preset region range corresponding to the component position is determined by combining the preset region range and the component position of the virtual component.

In one embodiment, the component position is a position determined based on a component center of the virtual component; the component position is a position determined based on any point on the virtual component; the component position is position determined based on a component bounding box corresponding to the virtual component; or the like.

In some embodiments, the at least one adjustment control having the accompanying association relationship with the virtual component is displayed in the preset region range by using the component center of the virtual component as the component position.

In some aspects, an example in which the component position is the component center of the virtual component is used. The component center is used as a display center of the preset region range, to determine the preset region range corresponding to the component position. The at least one adjustment control having the accompanying association relationship with the virtual component is displayed in the preset region range corresponding to the component position.

The at least one adjustment control distributed according to a preset control distribution rule is displayed by using the virtual component as the center, so that the adjustment control is displayed around the center of the virtual component, and the user can focus on a region including both the virtual component and the adjustment control, without switching attention between two different regions corresponding to the virtual component and the adjustment control, thereby facilitating operating the virtual component by the user by using the adjustment control, and increasing human-computer interaction efficiency.

In an embodiment, the preset region range corresponding to the virtual component is displayed in the virtual scene.

In some aspects, in response to the selection operation, the preset region range corresponding to the virtual component is displayed based on the component position of the virtual component in the virtual scene, and the at least one adjustment control having the accompanying association relationship with the virtual component is displayed in the preset region range. That is, the preset region range is representationally displayed in an interface.

In some embodiments, the accompanying association relationship exists between the preset region range and the virtual component, that is: when the preset region range configured for displaying the at least one adjustment control is displayed representationally, the accompanying association relationship is also configured for representing a relationship in which the preset region range changes as the component position changes.

In some embodiments, an example in which the preset region range is a circular region is used. When the preset region range corresponding to the virtual component is displayed based on the component position of the virtual component in the virtual scene, the circular region corresponding to the virtual component is displayed.

In one embodiment, a circular region that uses the virtual component as a circle center and a preset length as a radius is displayed as the preset region range corresponding to the virtual component.

In some aspects, the component center of the virtual component is determined based on the component position of the virtual component in the virtual scene, and then a circular region that uses the component center of the virtual component as a circle center and a preset length as a radius is displayed as the preset region range corresponding to the virtual component.

For example, a world coordinate system is established by using a point in the virtual scene, the component position of the virtual component in the virtual scene is determined based on a coordinate situation of the virtual component in the virtual scene, and position coordinates corresponding to the component center of the virtual component are determined, to display a circular region using the position coordinates as a circle center and a preset length as a radius.

In some aspects, when the virtual scene is a two-dimensional scene, the circular region is parallel to the world coordinate system; and when the virtual scene is a three-dimensional scene, the circular region is parallel to a plane corresponding to a display interface.

In one embodiment, when the virtual scene is a three-dimensional scene, a spherical region that uses the virtual component as a sphere center and a preset length as a radius is displayed as a spherical region corresponding to the virtual component.

In some aspects, the component center of the virtual component is determined based on the component position of the virtual component in the virtual scene, and then the spherical region that uses the component center of the virtual component as the sphere center and the preset length as the radius is displayed as the preset region range corresponding to the virtual component.

In some embodiments, the at least one adjustment control having the accompanying association relationship with the virtual component is displayed in the circular region.

In some aspects, the at least one adjustment control is arranged based on a preset control distribution situation, so that the at least one adjustment control is displayed in the circular region.

In some embodiments, the at least one adjustment control having the accompanying association relationship with the virtual component is displayed on a circular contour corresponding to the circular region.

In some aspects, an example in which the preset region range is a circular region is used. When the at least one adjustment control having the accompanying association relationship with the virtual component is displayed, the at least one adjustment control is displayed on the circular contour. When a plurality of adjustment controls are displayed, the plurality of adjustment controls are displayed on the circular contour without overlapping with each other.

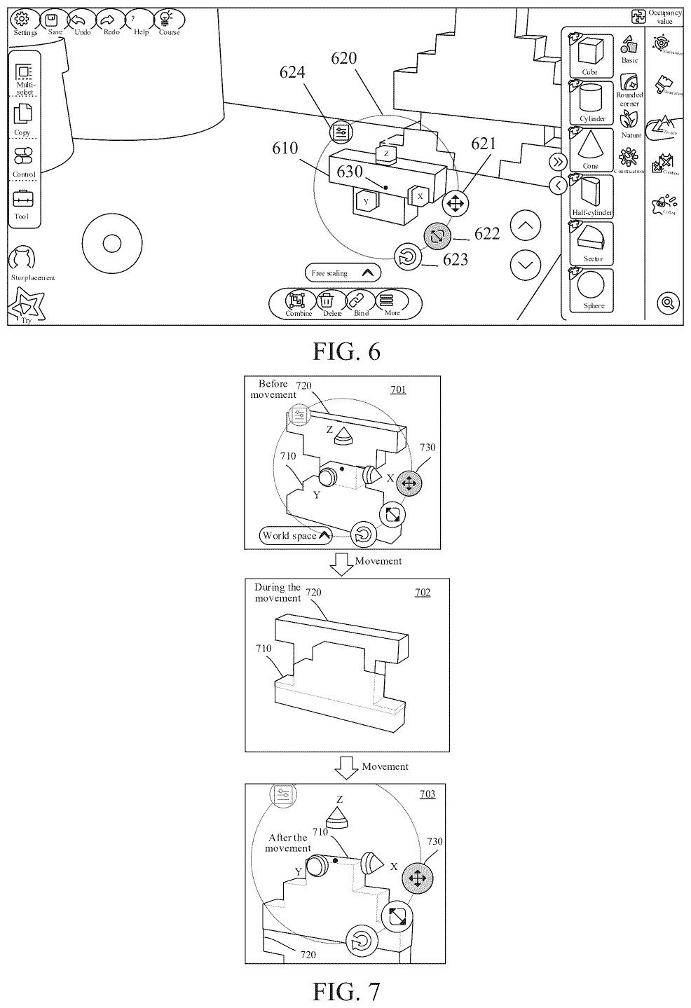

In some aspects, as shown in FIG. 5, the player performs the selection operation on the virtual component 510, and displays a game interface shown in FIG. 6. The game interface includes a virtual component 610. Based on a component position of the virtual component 610 in a virtual scene, at least one adjustment control having an accompanying association relationship with the virtual component is displayed. The at least one adjustment control includes an adjustment control 621, an adjustment control 622, an adjustment control 623, and an adjustment control 624.

The at least one adjustment control having the accompanying association relationship with the virtual component is displayed on a circular contour corresponding to a circular region that uses a component center of the virtual component as a circle center and a preset length as a radius, so that constraint on a position relationship between the virtual component and the adjustment control is implemented. The adjustment control is distributed on the circular contour around the virtual component, so that the adjustment control can be very conveniently viewed and operated by the user.

In one embodiment, as shown in FIG. 6, based on the component position of the virtual component 610 in the virtual scene, a circular region 620 having an accompanying association relationship with the virtual component is displayed as a preset region range corresponding to the virtual component, and the adjustment control 621, the adjustment control 622, an adjustment control 623, and an adjustment control 624 are displayed on a circular contour of the circular region 620.

In some embodiments, after operation 430, the method further includes: in response to an adjustment operation on the component position, displaying the virtual component whose component position is adjusted, and an animation in which the foregoing at least one adjustment control changes with a change in the component position.

The adjustment operation is configured for adjusting the component position of the virtual component. The adjustment operation may be a sliding operation, or may be in another form, such as a click/tap operation or a pinching and pulling operation. This is not limited in this disclosure. When the component position of the virtual component is adjusted by the user, the virtual component whose component position is adjusted is displayed. In addition, a display position of the at least one adjustment control changes with a change in the component position, and the animation in which the at least one adjustment control changes with a change in the component position is displayed, thereby performing accompanying display based on the accompanying association relationship.

In an embodiment, the at least one adjustment control includes a movement control, and the movement control is configured for adjusting the component position of the virtual component in the virtual scene.

In some aspects, a process in which the player triggers the movement control and displays a corresponding interface is implemented as the following operation 441 and operation 442.

Operation 441: Receive a first trigger operation on the movement control.

The first trigger operation is configured for moving the virtual component from a first position to a second position in the virtual scene. In some aspects, the first position and the second position are implemented as positions in the virtual scene, and the first position and the second position are different.

In one embodiment, the first trigger operation is implemented as at least one of a click/tap operation, a double-click/double-tap operation, a long-press operation, and the like.

In some aspects, the first trigger operation is implemented as the long-press operation. In a process of performing the long-press operation on the movement control, the movement control is dragged, and based on the accompanying association relationship between the adjustment control and the virtual component, a process of moving the virtual component is implemented. A position of the virtual component used before the movement control is dragged is the first position, and a position of the virtual component used after the movement control is dragged and released is the second position.

In some aspects, the first trigger operation is implemented as the click/tap operation, and a first click/tap operation performed on the movement control is used as a process of starting to move the virtual component. In this case, a position of the virtual component is the first position. A second click/tap operation performed on the movement control is used as a process of ending moving the virtual component, and a position targeted by the second click/tap operation is used as the second position of the virtual component after the virtual component is moved. Alternatively, a position targeted by a second click/tap operation is used as a position of the movement control used after the virtual component is moved, and then the second position used after the virtual component is moved is determined based on the accompanying association relationship between the adjustment control and the virtual component. For example, a distance between the movement control and the virtual component and a direction are preset, so that the second position of the virtual component can be determined based on the position of the movement control.

The foregoing descriptions are merely examples, and are not limited in embodiments of this disclosure.

Operation 442: During display of a movement animation in which the virtual component is moved from the first position to the second position, display, based on the accompanying association relationship between the virtual component and the at least one adjustment control in response to the first trigger operation, a movement following animation in which the at least one adjustment control follows movement of the virtual component.

In some aspects, the virtual component is moved from the first position to the second position based on the first trigger operation. Therefore, in a process of performing the first trigger operation, the movement animation in which the virtual component is moved from the first position to the second position is displayed in an interface.

The first position is a position of the virtual component in the virtual scene before the first trigger operation is performed, and the second position is a position of the virtual component in the virtual scene after the first trigger operation is performed.

In an embodiment, the movement following animation in which the at least one adjustment control follows movement of the virtual component is displayed based on the accompanying association relationship between the virtual component and the at least one adjustment control.

In one embodiment, the accompanying association relationship between the virtual component and the at least one adjustment control includes a preset distance relationship and a preset direction relationship separately corresponding to the virtual component and the at least one adjustment control.

In some aspects, an accompanying association relationship exists between the virtual component and an adjustment control 1 as well as an adjustment control 2, and the accompanying association relationship includes that a first preset distance relationship between the virtual component and the adjustment control 1 is one unit, and that a first preset direction relationship is that the adjustment control 1 is located 30° obliquely above the virtual component; and further includes that a second preset distance relationship between the virtual component and the adjustment control 2 is 1.5 units, and that a second preset direction relationship is that the adjustment control 2 is located 45° obliquely above the virtual component.

In one embodiment, when the virtual component is moved in the virtual scene based on the first trigger operation, based on the preset distance relationship and the preset direction relationship that are represented by the accompanying association relationship, when a preset distance relationship and a preset direction relationship between the virtual component and each adjustment component remain unchanged, a movement following animation in which the at least one adjustment control follows movement of the virtual component is displayed.

In an embodiment, the at least one adjustment control is hidden in response to receiving the first trigger operation; and display of the at least one adjustment control having the accompanying association relationship with the virtual component is restored in response to that the virtual component is located at the second position.

In some aspects, when the first trigger operation on the movement control is received, the at least one adjustment control is hidden in the interface, until the virtual component is moved to the second position at which the first trigger operation is ended, and display of the at least one adjustment control having the accompanying association relationship with the virtual component is restored, thereby avoiding interference of the at least one adjustment control to selection at the second position.

In an embodiment, another adjustment control different from the movement control is hidden in response to receiving the first trigger operation; and display of the another adjustment control having an accompanying association relationship with the virtual component is restored in response to that the virtual component is located at the second position.

In some aspects, the adjustment control having the accompanying association relationship with the virtual component includes a plurality of adjustment controls. When the first trigger operation performed on a movement control among the plurality of adjustment controls is received, the other adjustment controls than the movement control are hidden in the interface, and display of the other adjustment controls are restored until the virtual component is moved to the second position at which the first trigger operation is ended.

In some embodiments, FIG. 7 is a schematic diagram of an interface for performing a first trigger operation on a movement control. The interface 701 includes a virtual component 710 and a virtual component 720, and the virtual component 710 is located at a first position. At least one adjustment control having an accompanying association relationship with the virtual component 710 is displayed based on a selection operation on the virtual component 710, and the at least one adjustment control includes a movement control 730. A movement process shown in, for example, an interface 702 is displayed based on the first trigger operation on the movement control 730. For example, an objective of the first trigger operation is to move the virtual component 710 onto the virtual component 720. After the virtual component 710 is moved from the first position to a second position (a position on the virtual component 720), a movement completion process shown in, for example, an interface 703 is displayed.

The foregoing descriptions are merely examples, and are not limited in embodiments of this disclosure.

In the foregoing manner, when a position of a virtual component in a virtual scene changes, a display position of an adjustment control also synchronously changes, thereby implementing an accompanying display effect.

In an embodiment, the at least one adjustment control includes a size adjustment control, and the size adjustment control is configured for adjusting a component size of the virtual component in the virtual scene.

In some aspects, a process in which a player triggers the size adjustment control and displays a corresponding interface is implemented as the following operation 451 and operation 452.

Operation 451: Receive a second trigger operation on the size adjustment control.

The second trigger operation is configured for adjusting the virtual component from a first component size to a second component size.

In one embodiment, the component size is configured for representing a region area occupied by the virtual component in the virtual scene. For example, the virtual component is a two-dimensional component element, and the component size is configured for representing a component area of the virtual component; or the virtual component is a three-dimensional component element, and the component size is configured for representing a floor area occupied by the virtual component in the virtual scene.

In one embodiment, the component size is configured for representing a region volume occupied by the virtual component in the virtual scene. For example, the virtual component is a three-dimensional component element, and the component size is configured for representing a space volume occupied by the virtual component in the virtual scene.

For example, the first component size and the second component size use a same measurement standard. For example, each of the first component size and the second component size represents a region volume occupied by the virtual component in the virtual scene; or each of the first component size and the second component size represents a region area occupied by the virtual component in the virtual scene (an area of or a floor area occupied by the component).

In some embodiments, if the first component size is less than the second component size, the first trigger operation is an operation of scaling up the virtual component. Alternatively, if the first component size is greater than the second component size, the first trigger operation is an operation of scaling down the virtual component.

In one embodiment, the second trigger operation is implemented as at least one of a click/tap operation, a double-click/double-tap operation, a long-press operation, and the like.

In some embodiments, the virtual component includes a first component reference point used as reference information in a component size adjustment process. In some aspects, the first component reference point is a component center of the virtual component; the first reference point is a component vertex of the virtual component; or the first component reference point is any point on the virtual component.

Operation 452: During display of a size adjustment animation in which the virtual component is adjusted from the first component size to the second component size, display, based on the accompanying association relationship between the virtual component and the at least one adjustment control in response to the second trigger operation, a first accompanying animation in which the at least one adjustment control moves along with the first component reference point.

In some aspects, the virtual component is adjusted from the first component size to the second component size based on the second trigger operation. Therefore, in a process of performing the second trigger operation, the size adjustment animation in which the virtual component is adjusted from the first component size to the second component size is displayed in the interface.

The first component size is a component size of the virtual component displayed in the virtual scene before the second trigger operation is performed, and the second component size is a component size of the virtual component displayed in the virtual scene after the second trigger operation is performed.

In some aspects, a size of the virtual component changes in the component size adjustment process, and in this case, a position of a predetermined first component reference point in the virtual scene also changes. Therefore, in addition to displaying the size adjustment animation, the first accompanying animation in which the at least one adjustment control moves along with the first component reference point is displayed.

For example, a movement animation formed by the at least one adjustment control by using the first component reference point as a center point is used as the first accompanying animation.

In an embodiment, a size change animation in which the at least one adjustment control adjusts a size along with the virtual component is displayed based on the accompanying association relationship between the virtual component and the at least one adjustment control.

In some aspects, in a process of performing a change from the first component size to the second component size, size adjustment ratios at different moments are determined in real time, and the at least one adjustment control is separately adjusted at the size adjustment ratio at the corresponding moment, to display the size change animation in which the at least one adjustment control adjusts the size along with the virtual component.

In an embodiment, the at least one adjustment control is hidden in response to receiving the second trigger operation; and display of the at least one adjustment control having the accompanying association relationship with the virtual component is restored in response to that the virtual component is adjusted to the second component size.

In some aspects, when the second trigger operation on the size adjustment control is received, the at least one adjustment control is hidden in the interface, until the component size of the virtual component is adjusted to the second component size used when the second trigger operation is ended, and display of the at least one adjustment control having the accompanying association relationship with the virtual component is restored, thereby avoiding interference of the at least one adjustment control to the size adjustment process.

In an embodiment, another adjustment control different from the size adjustment control is hidden in response to receiving the second trigger operation; and display of the another adjustment control having the accompanying association relationship with the virtual component is restored in response to that the virtual component is adjusted to the second component size.

In some aspects, the adjustment control having the accompanying association relationship with the virtual component includes a plurality of adjustment controls. When the second trigger operation performed on the size adjustment control among the plurality of adjustment controls is received, the other adjustment controls than the size adjustment control are hidden in the interface, and display of the other adjustment controls are restored until the component size of the virtual component is adjusted to the second component size used when the second trigger operation is ended.

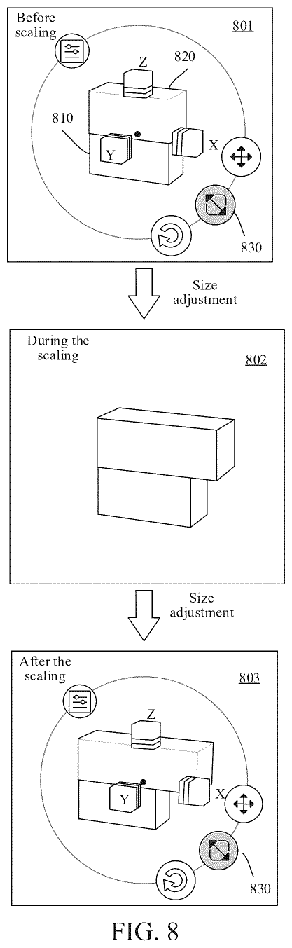

In some embodiments, FIG. 8 is a schematic diagram of an interface for performing a second trigger operation on a size adjustment control. The interface 801 includes a virtual component 810 and a virtual component 820, and the virtual component 810 corresponds to a first component size. At least one adjustment control having an accompanying association relationship with the virtual component 810 is displayed based on a selection operation on the virtual component 810, and the at least one adjustment control includes a size adjustment control 830. A size adjustment process shown in, for example, an interface 802 is displayed based on the second trigger operation on the size adjustment control 830. For example, an objective of the second trigger operation is to change the first component size of the virtual component 810 to a larger second component size. After the virtual component 810 is adjusted from the first component size to the second component size, a size adjustment completion process shown in, for example, an interface 803 is displayed.

The foregoing descriptions are merely examples, and are not limited in embodiments of this disclosure.

In the foregoing manner, when a size of the virtual component in a virtual scene changes, a display position of the adjustment control also synchronously changes, thereby implementing an accompanying display effect.

In an embodiment, the at least one adjustment control includes an angle adjustment control, and the angle adjustment control is configured for adjusting a display angle of the virtual component relative to the virtual scene.

In some aspects, a process in which a player triggers the angle adjustment control and displays a corresponding interface is implemented as the following operation 461 and operation 462.

Operation 461: Receive a third trigger operation on the angle adjustment control.

The third trigger operation is configured for adjusting the virtual component from a first rotation angle to a second rotation angle.

In one embodiment, a rotation angle is implemented as a rotation situation of the virtual component relative to at least one coordinate axis in the virtual scene. In some aspects, the virtual scene is a three-dimensional scene, and the virtual scene corresponds to a world coordinate system, including a horizontal axis, a longitudinal axis, and a vertical axis. The rotation angle may be implemented as a rotation situation of the virtual component relative to the horizontal axis, the longitudinal axis, or the vertical axis in the virtual scene, may be implemented as a rotation situation of the virtual component relative to any two of the horizontal axis, the longitudinal axis, and the vertical axis in the virtual scene, or may be implemented as a rotation situation of the virtual component relative to the horizontal axis, the longitudinal axis, and the vertical axis in the virtual scene.

For example, the first rotation angle and the second rotation angle are implemented as different angles.

In one embodiment, the third trigger operation is implemented as at least one of a click/tap operation, a double-click/double-tap operation, a long-press operation, and the like.

In some embodiments, the virtual component includes a second component reference point used as reference information in a rotation angle adjustment process. In some aspects, the second component reference point is a component center of the virtual component; the second component reference point is a component vertex of the virtual component; or the second component reference point is any point on the virtual component.

In one embodiment, the first component reference point and the second component reference point may be the same reference point, or may be different reference points.

Operation 462: During display of a component rotation animation in which the virtual component is adjusted from the first rotation angle to the second rotation angle, display, based on the accompanying association relationship between the virtual component and the at least one adjustment control in response to the third trigger operation, a second accompanying animation in which the at least one adjustment control moves along with the second component reference point.

In some aspects, the virtual component is adjusted from the first rotation angle to the second rotation angle based on the third trigger operation. Therefore, in a process of performing the third trigger operation, the component rotation animation in which the virtual component is adjusted from the first rotation angle to the second rotation angle is displayed in the interface.

The first rotation angle is configured for presenting an angle presentation situation (for example, a positive viewing angle) that is of the virtual component in the virtual scene and that is used before the third trigger operation is performed. The second rotation angle is configured for presenting angle presentation (for example, a side viewing angle) that is of the virtual component in the virtual scene and that is used after the third trigger operation is performed.

In some aspects, a size of the virtual component changes in the rotation angle adjustment process, and in this case, a position of a predetermined second component reference point in the virtual scene also changes. Therefore, in addition to displaying the component rotation animation, the second accompanying animation in which the at least one adjustment control moves along with the second component reference point is displayed.

For example, a movement animation formed by the at least one adjustment control by using the second component reference point as a center point is used as the second accompanying animation.

In an embodiment, the movement following animation in which the at least one adjustment control follows movement of the virtual component is displayed based on the accompanying association relationship between the virtual component and the at least one adjustment control.

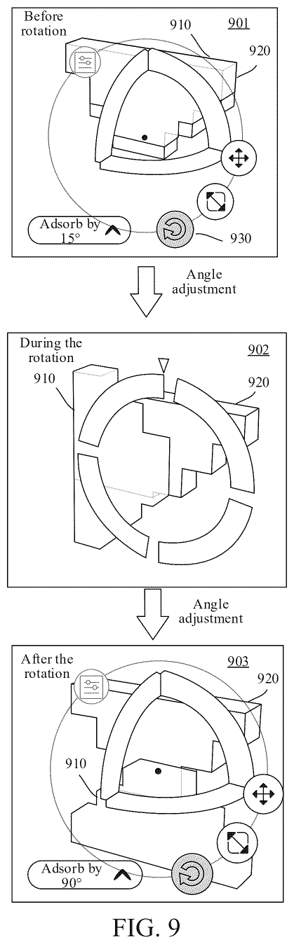

In some embodiments, FIG. 9 is a schematic diagram of an interface for performing a third trigger operation on an angle adjustment control. The interface 901 includes a virtual component 910 and a virtual component 920 (the virtual component 920 is shielded by the virtual component 910 in the interface 901), and the virtual component 910 corresponds to a first rotation angle. At least one adjustment control having an accompanying association relationship with the virtual component 910 is displayed based on a selection operation on the virtual component 910, and the at least one adjustment control includes an angle adjustment control 930. An angle adjustment process shown in, for example, an interface 902 is displayed based on the third trigger operation on the angle adjustment control 930. For example, an objective of the third trigger operation is to change a first rotation angle of the virtual component 910 to a second rotation angle. After the virtual component 910 is adjusted from the first rotation angle to the second rotation angle, an angle adjustment completion process shown in, for example, an interface 903 is displayed.

The foregoing descriptions are merely examples, and are not limited in embodiments of this disclosure.

In the foregoing manner, when a display angle of the virtual component in a virtual scene changes, a display position of the adjustment control also synchronously changes, thereby implementing an accompanying display effect.

In an embodiment, the at least one adjustment control includes a function expansion control, and the function expansion control is configured for expanding and displaying another function control.

In some aspects, a process in which a player triggers the function expansion control and displays a corresponding interface is implemented as the following operation 471 and operation 472.

Operation 471: Receive a fourth trigger operation on the function expansion control.

The fourth trigger operation is configured for expanding and displaying another function control. The another function control is a function control different from the at least one function control, and is configured for implementing an adjustment function different from that of the at least one function control.

In one embodiment, the another function control includes a plurality of controls that implement other functions, such as a color adjustment control, a skin decoration control, and a display setting control.

In some aspects, the color adjustment control is configured for adjusting a color of the virtual component, for example, adjusting the color of the virtual component by using a color presetting option; or adjusting the color of the virtual component through a palette operation. The skin decoration control is configured for adjusting a component skin of the virtual component, for example, decorating the virtual component by using a purchased skin; or changing a skin for the virtual component. The display setting control is configured for setting, in a targeted manner, content such as display duration and display transparency of the virtual component.

Operation 472: Display a function control list in response to the fourth trigger operation.

The function control list includes another function control.

In one embodiment, a corresponding configuration interface is displayed for a trigger operation on the another function control, and a process of adjusting the virtual component in a more detailed manner is implemented through a process of configuring the configuration interface.

In some embodiments, the another function control is displayed in the function control list through a control selection operation.

In some aspects, a player may change, through the control selection operation, the another function control displayed in the function control list. For example, in a default configuration, the function control list includes a function control 1 and a function control 2, and the player changes, through the control selection operation, the function controls displayed in the function control list. For example, a function control 3 used by the player is added to the function control list; or the function control 1 is adjusted to a function control 3 used by the player.

At least one other function control can be displayed by using the function expansion control, thereby accommodating more function controls in a limited display region, and better meeting a use requirement of a user.

In some embodiments, the at least one adjustment control having the accompanying association relationship with the virtual component is displayed based on historical adjustment data.

In some aspects, the historical adjustment data is configured for representing a situation of triggering a plurality of adjustment controls within a historical time period. The plurality of adjustment controls are configured for obtaining the at least one adjustment control through filtering.

In one embodiment, the historical adjustment data includes a quantity of times of triggering the plurality of adjustment controls within the historical time period.

For example, 10 adjustment controls are preset. Based on the historical adjustment data representing a relatively large quantity of times the player triggers an adjustment control 1 and an adjustment control 2 among the 10 adjustment controls within the historical time period, and a relatively small quantity of times of triggering the other adjustment controls, when the at least one adjustment control having the accompanying association relationship with the virtual component is displayed, the adjustment control 1 and the adjustment control 2 are used as the at least one adjustment control having the accompanying association relationship with the virtual component.

In some embodiments, the another function control is displayed in the function control list based on the historical adjustment data.

In some aspects, among the at least one adjustment control, an adjustment control other than the function expansion control is configured by default or configured by the player. Therefore, the another function control included in the function control list is an adjustment control that is out of a default configuration, or an adjustment control that is determined based on a quantity of times of triggering the plurality of adjustment controls within the historical time period.

The foregoing descriptions are merely examples, and are not limited in embodiments of this disclosure.

The at least one adjustment control having the accompanying association relationship with the virtual component is displayed based on the historical adjustment data, so that an adjustment control that is used by the user a relatively large quantity of times within the historical time period can be preferentially displayed, thereby better meeting a use requirement of the user while meeting a personalized display requirement of the adjustment control.

In this embodiment of this disclosure, the processes of differently adjusting the virtual component by using the adjustment controls having the different adjustment functions are described, so that a fast adjustment can be implemented around the virtual component by using the at least one adjustment control having the accompanying association relationship, thereby avoiding a problem of low efficiency that the player needs to view and trigger two regions having a relatively large span to implement an adjustment. In this way, adjustment efficiency is increased, and a more diverse adjustment is performed on the virtual component, thereby improving application flexibility of the virtual component.

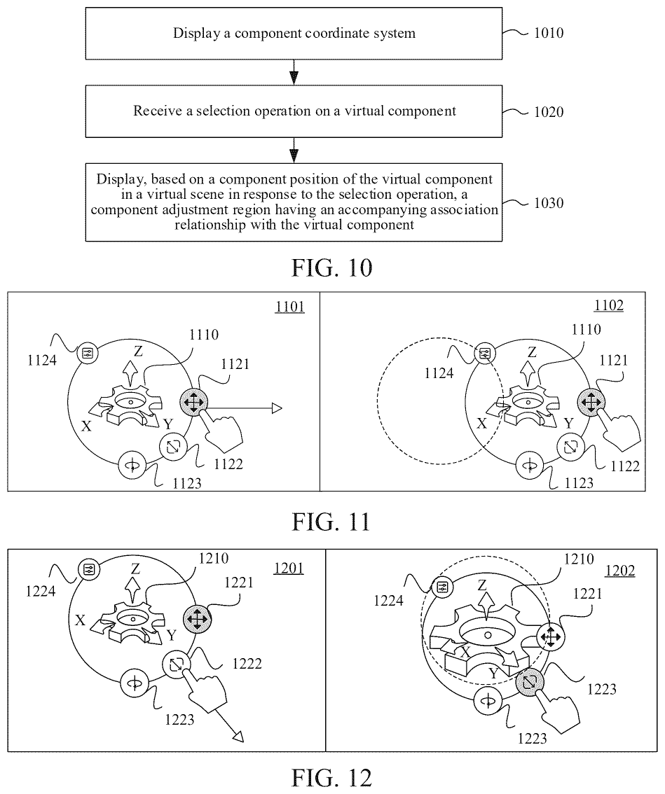

In an embodiment, the at least one adjustment control is displayed in a component adjustment region corresponding to the component position, and the component adjustment region is configured for uniformly managing a display status of the at least one adjustment control. In some aspects, as shown in FIG. 10, the embodiment shown in FIG. 3 may alternatively be implemented as operation 1010 to operation 1030 described below.

Operation 1010: Display a virtual component.

The virtual component is a component element located in a virtual scene.

In some aspects, operation 1010 is described in operation 310 and operation 410 described above. Details are not described herein again.

Operation 1020: Receive a selection operation on the virtual component.

In one embodiment, the selection operation is implemented as at least one of a plurality of operation manners such as a click/tap operation, a long-press operation, and a voice trigger operation.

Operation 1030: Display, based on a component position of the virtual component in the virtual scene in response to the selection operation, the component adjustment region having an accompanying association relationship with the virtual component.

The component adjustment region includes at least one adjustment control.

In some aspects, in addition to representing a relationship in which the at least one adjustment control changes with a change in the component position, the accompanying association relationship is further configured for representing a relationship in which the component adjustment region changes with a change in the component position.

The adjustment control is configured for adjusting a display status of the virtual component in the virtual scene.

In some embodiments, a control trigger operation on a region movement control is received, and a region movement animation in which the component adjustment region is moved in the virtual scene is displayed.

In some aspects, a region movement control exists in the component adjustment region, and the region movement control is configured for independently moving the component adjustment region. That is, through a process of triggering the region movement control, the component adjustment region can be independently moved without moving the virtual component.

The region movement animation is configured for representing an animation in which the component adjustment region is moved in the virtual scene.

In one embodiment, the component adjustment region is moved in a preset movement range based on the accompanying association relationship existing between the component adjustment region and the virtual component.

In some aspects, a movement range is set for the component adjustment region as the preset movement range based on the accompanying association relationship existing between the component adjustment region and the virtual component, and the component adjustment region is limited to be moved in the preset movement range.

In one embodiment, prompt information is displayed based on the accompanying association relationship between the virtual component and the component adjustment region in response to that the control trigger operation indicates to move the component adjustment region out of the preset movement range corresponding to the virtual component. The prompt information is configured for prompting to move the component adjustment region in the preset movement range.

For example, when a specified region selected by a player for the component adjustment region exceeds the preset movement range, the prompt information (such as text information or a red prompt animation) is displayed to prompt the player that a process of moving the component adjustment region in the preset movement range needs to be performed.

The foregoing descriptions are merely examples, and are not limited in embodiments of this disclosure.

In some embodiments, as shown in FIG. 11, a component adjustment region presented as a circular region is displayed based on a selection operation on a virtual component 1110. The component adjustment region includes a plurality of adjustment controls that are respectively an adjustment control 1121, an adjustment control 1122, an adjustment control 1123, and an adjustment control 1124.

In one embodiment, the adjustment control 1121 is a movement control, configured for moving the virtual component 1110 from a current first position to a second position. As shown in an interface 1101, a first trigger operation is performed on the adjustment control 1121, to move the adjustment control 1121 to the second position, and an interface 1102 is displayed. Based on accompanying association relationships between the plurality of adjustment controls and the virtual component 1121, the plurality of adjustment controls accompany the virtual component 1121 to synchronously move.

In some embodiments, as shown in FIG. 12, a component adjustment region presented as a circular region is displayed based on a selection operation on a virtual component 1210. The component adjustment region includes a plurality of adjustment controls that are respectively an adjustment control 1221, an adjustment control 1222, an adjustment control 1223, and an adjustment control 1224.

In one embodiment, the adjustment control 1221 is a size adjustment control, configured for adjusting the virtual component 1210 from a current first component size to a second component size. As shown in an interface 1201, a second trigger operation is performed on the adjustment control 1221, to adjust the adjustment control 1221 to the second component size, and an interface 1202 is displayed. In one embodiment, based on accompanying association relationships between the plurality of adjustment controls and the virtual component 1221, the plurality of adjustment controls accompany the virtual component 1221 to perform a synchronous size adjustment process.

The foregoing descriptions are merely examples, and are not limited in embodiments of this disclosure.

In this embodiment of this disclosure, a component adjustment region that has an accompanying association relationship with the virtual component is further described, and content of at least one adjustment control is displayed by using the component adjustment region. It is beneficial to more uniformly manage the at least one adjustment control by using the component adjustment region. Through an independent trigger operation on the component adjustment region, flexibility may further be added to the component adjustment process by using the component adjustment region without affecting an operation of the player on the virtual component, thereby increasing human-computer interaction efficiency.

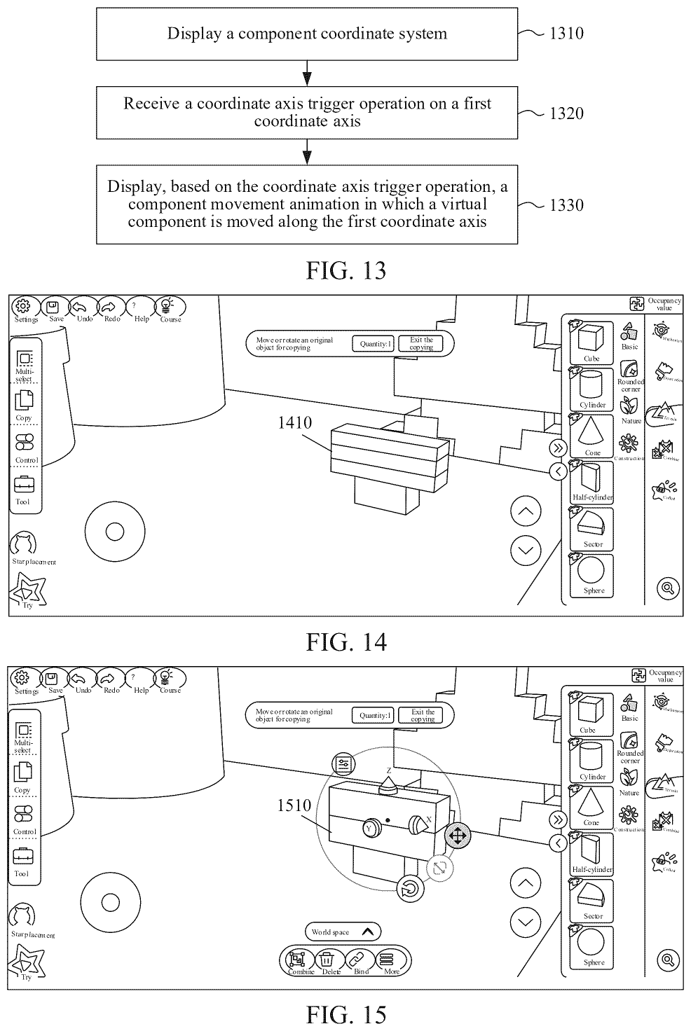

In an embodiment, in addition to the at least one adjustment control, a component coordinate system is further displayed. The component coordinate system is a coordinate system determined based on the component position of the virtual component in the virtual scene. Situations such as a position situation and a placement angle of the virtual component are analyzed in a more targeted manner by using the component coordinate system. In some aspects, as shown in FIG. 13, the embodiment shown in FIG. 3 further includes operation 1310 to operation 1330 described below.

Operation 1310: Display a component coordinate system.

The component coordinate system is a coordinate system determined based on a component position of a virtual component in a virtual scene.

In one embodiment, the component coordinate system is a coordinate system established based on a component center of the virtual component. For example, the component coordinate system is a three-dimensional coordinate system, the component center is used as an origin of the component coordinate system, a line is selected as a horizontal axis of the component coordinate system, and a longitudinal axis and a vertical axis of the component coordinate system are correspondingly determined, to establish the component coordinate system.

In some aspects, a selection operation is performed on the virtual component, and in addition to at least one adjustment control having an accompanying association relationship with the virtual component, the component coordinate system determined based on the component position of the virtual component in the virtual scene is further displayed.

In one embodiment, the component coordinate system includes at least two coordinate axes, and the at least two coordinate axes include a first coordinate axis.

In some aspects, the first coordinate axis is any one of the at least two coordinate axes. For example, the first coordinate axis is implemented as a horizontal axis X; the first coordinate axis is implemented as a longitudinal axis Y; or the first coordinate axis is implemented as a vertical axis Z.

As shown in FIG. 6, in addition to displaying the at least one adjustment control based on the selection operation, the component coordinate system that includes the horizontal axis X, the longitudinal axis Y, and the vertical axis Z and that is established based on the component position (for example, a component center 630) is further displayed.

Operation 1320: Receive a coordinate axis trigger operation on the first coordinate axis.

The coordinate axis trigger operation is configured for moving the virtual component along a direction of the first coordinate axis.

In one embodiment, the component coordinate system and the at least one adjustment control are hidden based on the coordinate axis trigger operation.

In some aspects, as shown in FIG. 6, an example in which the first coordinate axis is a Y axis is used. A click/tap operation on the Y axis is received as a coordinate axis trigger operation, and an interface shown in FIG. 14 is displayed. A virtual component 1410 is displayed in the interface, and the at least one adjustment control and the component coordinate system are hidden.

In one embodiment, a sliding operation on the first coordinate axis is received as a coordinate axis trigger operation.

In some aspects, a movement situation of the virtual component on the first coordinate axis is adjusted based on the sliding operation on the first coordinate axis.

Operation 1330: Display, based on the coordinate axis trigger operation, a component movement animation in which the virtual component is moved along the first coordinate axis.

In some aspects, for an interface shown in FIG. 14, a virtual component 1410 is displayed in the interface. An example in which the first coordinate axis is a Y axis is used. A sliding operation on the Y axis is received as a coordinate axis trigger operation, so that the virtual component 1410 slides on the Y axis, and a component movement animation in which the virtual component is moved along the first coordinate axis is displayed.

In one embodiment, based on the foregoing coordinate axis trigger operation, the virtual component can be moved upward in a more horizontal position in a targeted manner.

In some embodiments, when the component coordinate system is in a hidden state, the component movement animation in which the virtual component is moved along a hidden first coordinate axis is displayed.

In some aspects, as shown in FIG. 15, after a virtual component 1510 is horizontally moved to a specified position in a direction of a coordinate axis, display of the at least one adjustment control and the component coordinate system is restored.

In some embodiments, as shown in FIG. 15, a plurality of function controls, such as a multiple-selection control, a copy control, a control control, a tool control, a combination control, a deletion control, and a binding control, are further displayed in the interface.

In one embodiment, through user-defined setting, the function control may alternatively be used as the at least one adjustment control having an accompanying relationship with the virtual component.

The foregoing descriptions are merely examples, and are not limited in embodiments of this disclosure.

In this embodiment of this disclosure, it is described that in addition to further displaying the adjustment control, the component coordinate system may further be displayed. A smoother adjustment process is performed on the virtual component through the coordinate axis trigger operation on the coordinate axis in the component coordinate system, to implement a process of moving the virtual component in a horizontal direction in a targeted manner. In addition, it is further beneficial to view detailed information such as a current rotation situation of the virtual component by using the component coordinate system, thereby improving control of a player on the virtual component.

A coordinate axis control is an operation control that is in a touchscreen mobile terminal and that switches a form of a three-dimensional coordinate axis through clicking/tapping. In some aspects, the coordinate axis control includes a plurality of adjustment controls such as “movement”, “scaling”, “rotation”, and “advanced editing”.

In a related technology, coordinate axis controls on the touchscreen mobile terminal are of a fixed type, that is, the plurality of adjustment controls are fixedly displayed at a lower position of the screen. When an adjustment process is performed based on the adjustment control, a player needs to frequently switch an attention focus and an operation position between an adjustment control and a lower operating console.

The fixed type is configured for representing a form in which the adjustment control is fixed at a specified position of the screen and does not change as the component position of the virtual component changes.

That is, the coordinate axis controls in the foregoing process are of the fixed type, are separated from a coordinate axis body, and are always located at a lower portion of the screen. Therefore, when the player triggers the adjustment control thereamong, it is not conducive to concentration of the player and a more convenient operation.

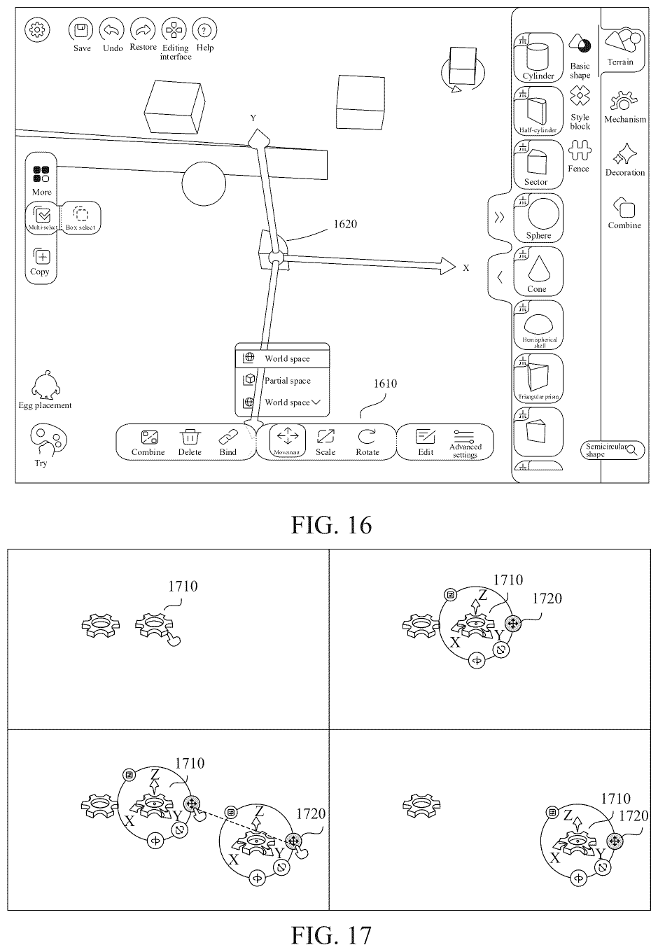

In some aspects, FIG. 16 is a schematic diagram of an interface in a related technology. A plurality of adjustment controls 1610 are fixedly displayed at a lower position of a screen. Although a player can perform an adjustment process on a virtual component 1620 by using the adjustment control 1610, adjustment efficiency is relatively low.

In an embodiment, the foregoing virtual component configuration method is referred to as “a method for operating a floating coordinate axis control in a mobile end editor”. That is, compared with a fixed-type manner, in this embodiment of this disclosure, the coordinate axis control is presented in a floating manner. The floating manner is configured for representing a form in which the adjustment control changes a position as a component position of a selected virtual component in a game scene changes.

In one embodiment, the foregoing virtual component configuration method is applied to a user-generated-content (UGC) mode.

An example of triggering a movement control among the adjustment controls is used. As shown in FIG. 17, after a player clicks/taps and selects a virtual component 1710 in a scene, a component coordinate system and at least one adjustment control having an accompanying association relationship with the virtual component 1710 are generated around the virtual component, and the at least one adjustment control includes a movement control 1720. When the player moves to change a position of the virtual component in the virtual scene (that is, based on a first trigger operation on the movement control 1720), positions of the component coordinate system and the adjustment control are synchronously changed. For example, the virtual component 1710 moves from a first position to a second position, and the component coordinate system is correspondingly moved. The adjustment control also correspondingly moves based on the accompanying association relationship. In some aspects, positions of the component coordinate system and the adjustment control relative to a component origin of the virtual component remain unchanged.

In an embodiment, a three-dimensional operation transformation process performed by the player on a cubic virtual component is used as an example.

As shown in FIG. 5, an unselected virtual component 510 is included. In this case, the interface shown in FIG. 6 is displayed after the virtual component 510 is clicked/tapped. A floating circular ring (a component adjustment region) and a component coordinate system are generated by using the virtual component 510 as a center. Four adjustment controls in arc distribution on the circular ring are a movement control, a scaling control (a size adjustment control), a rotation control (an angle adjustment control), and another setting control. Then, sliding transformation is performed on the virtual component by clicking/tapping any coordinate axis (a first coordinate axis) in the component coordinate system, and the interface in FIG. 14 is displayed. The component coordinate axis and the floating circular ring (the component adjustment region) are hidden in the interface. In this case, a finger of the player performs a dragging operation on a screen. When the finger is released, the floating circular ring and the component coordinate system are generated again by using a new component origin as a circle center, as shown in FIG. 15.

In an embodiment, technical side content of the virtual component configuration method is described.

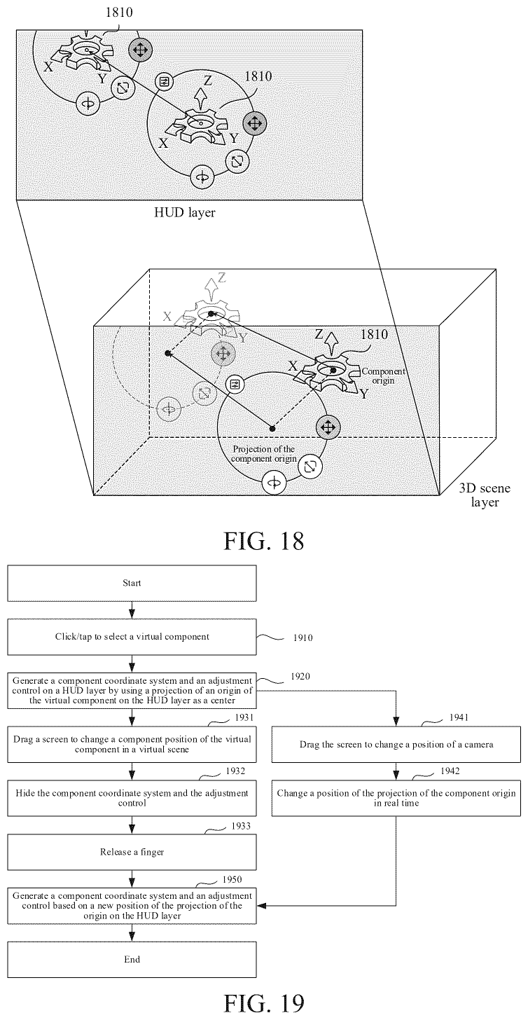

In some aspects, as shown in FIG. 18, when a virtual component 1810 is selected for the first time, a floating coordinate axis control layer (that is, a component adjustment region configured for displaying at least one adjustment control) is generated by using a projection of an origin (for example, a component center) of the virtual component 1810 on a head-up display (HUD) layer as a circle-center positioning point. The HUD layer includes a plurality of display layers. The component adjustment region is used as one of the display layers, and is located above the HUD layer. The other display content is used as the other display layers located below the HUD layer, that is, a layer level is a lowest layer of another UI of the HUD layer.

In some aspects, when the player changes a position of the virtual component 1810 in a virtual scene through movement, scaling, or rotation, or in another editing manner, a control layer corresponding to the component coordinate system is hidden in an adjustment process. When the player releases a finger, a new floating coordinate axis control layer is generated again by using the component center of the virtual component 1810 as a new original position, and the projection on the HUD layer as a circle center.

In one embodiment, when the player does not change positioning of the virtual component in the virtual scene, but changes a position of a camera by dragging a screen, a position of the HUD layer relative to the virtual scene is continuously changed, a projection of a component origin of the virtual component on the HUD coordinate axis control layer is also continuously changed, and the corresponding coordinate axis control layer is also continuously changed with a positioning point, to form a “floating” feeling.

In an embodiment, as shown in FIG. 19, a technical implementation flowchart is described below.

Operation 1910: Click/tap a virtual component.

In some aspects, a click/tap operation on the virtual component is used as a selection operation on the virtual component.

Operation 1920: Generate a component coordinate system and an adjustment control on a HUD layer by using a projection of an origin of the virtual component on the HUD layer as a center.

In some aspects, when a player does not select the virtual component, the component coordinate system and the adjustment control are in a hidden state. When the player clicks/taps to select the virtual component, the component coordinate system and the adjustment control are switched to a display status, and positions of the component coordinate system and the adjustment control on a screen are calculated by using an origin of a relative coordinate system of a blueprint of the virtual component as a circle-center anchor point.

In one embodiment, when the player inputs an operation to change a relative position of the virtual component to a game camera, a position of the component coordinate system is correspondingly changed, to achieve a visual transformation effect similar to “floating” on the screen. That is, based on different operations performed by the player on the screen, the following operation 1931 to operation 1933, or operation 1941 and operation 1942 are implemented.

Operation 1931: Drag a screen to change a component position of a virtual component in a virtual scene.

In some aspects, the player moves the virtual component in the virtual scene by dragging a movement control that is in the screen and that is configured for adjusting the component position. Correspondingly, the virtual scene displayed in an interface may be changed.

When the player changes the component position of the virtual component in the virtual scene by dragging the screen, the following operation 1932 is performed.

Operation 1932: Hide a component coordinate system and an adjustment control.

In some aspects, when the component position of the virtual component in the virtual scene is changed, the component coordinate system and the adjustment control that are displayed based on a selection operation are hidden, that is, a user interface (UI) of the component coordinate system and the adjustment control is hidden.

Operation 1933: Release a finger.

In some aspects, the player ends, through a finger releasing operation, an operation of dragging the screen to change the component position, and a terminal performs the following operation 1950 based on the finger releasing operation.

That is, in the foregoing operation 1931 to operation 1933, when a position of a camera displaying the virtual scene remains unchanged, when the player changes a component position or a component size of the virtual component in a game editor, a position of the virtual component relative to the camera is affected and changed. In this case, a corresponding player operation is dragging a touchscreen. When it is detected that the player triggers this operation, the component coordinate system and the adjustment control are switched to a hidden state. After the operation is ended (that is, after the player releases the finger), the component coordinate system and the adjustment control are switched to a display status again by using a new position of a component origin of the virtual component as an anchor point.

Operation 1941: Drag the screen to change the position of the camera.

In some aspects, the player adjusts, by dragging the screen, the position of the camera configured for displaying the virtual scene. Because the position of the camera is changed, the virtual scene displayed in the interface is changed. In addition, because the virtual component is located in the virtual scene, a position of the virtual component relative to the interface is changed.

Operation 1942: Change a position of a projection of the component origin in real time.

In some aspects, the virtual scene displayed in the interface is changed based on a change of the position of the camera. In this case, a display position of the virtual component relative to the virtual scene in the interface is also changed. To smoothly adjust the change in the interface, the component origin (for example, a component center) of the virtual component is determined, and the position of the projection of the component origin is changed in real time based on a real-time adjustment of the position of the camera, to form a smoother scene change process.

That is, in operation 1941 and operation 1942, the component position of the virtual component remains unchanged, and the player drags the screen to change a viewing angle of the game camera and changes a position of an anchor point (for example, the component origin of the virtual component) relative to the camera. When it is detected that the player triggers this operation, the component coordinate system is not switched to a hidden state, but the position of the anchor point is detected in real time, and the positions of the component coordinate system and the adjustment control are changed.

Operation 1950: Generate a component coordinate system and an adjustment control based on a new position of the projection of the origin on the HUD layer.

In some aspects, after the foregoing operation 1933 or operation 1942 is ended, a terminal determines the new position of the projection of the component origin of the virtual component on the HUD layer, and generates the component coordinate system and the adjustment control at the position.

In the foregoing process, because the component coordinate system and the adjustment control are not located at fixed positions, a corresponding adjustment control may be additionally added to more efficiently implement different editing functions. In some aspects, dragging the movement control may respond to plane movement, dragging the size adjustment control may respond to overall scaling, and dragging the angle adjustment control may respond to a plane rotation function.

The foregoing descriptions are merely examples, and are not limited in embodiments of this disclosure.

In this embodiment of this disclosure, the foregoing method may be applied to an interface editor of a game or an application program, thereby reducing an operation path in a process in which the user edits the component coordinate system and the adjustment control, facilitating finding a corresponding adjustment control more quickly around the component position, performing alternate behavior of editing the virtual component and operating the adjustment control on the screen by using a shortest path, facilitating focusing always on the virtual component object by the user, reducing interference of the process of operating the component coordinate system and the adjustment control to a creation process of the player, expanding an editing capability, and increasing creation efficiency of the player. Therefore, the editing capability is more efficiently improved by using a dragging function of the virtual control, and editing efficiency of the user is increased.

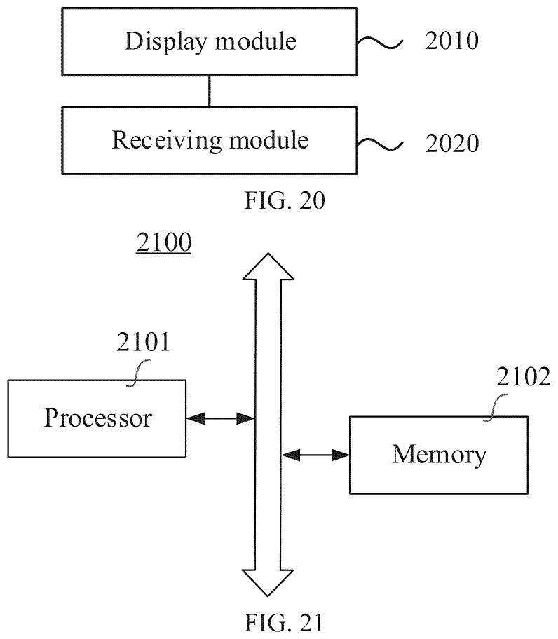

FIG. 20 is a block diagram of a structure of a virtual component configuration apparatus according to an embodiment of this disclosure. As shown in FIG. 20, the apparatus includes the following parts:
a display module 2010, configured to display a virtual component, the virtual component being a component element located in a virtual scene; and
a receiving module 2020, configured to receive a selection operation on the virtual component,
the display module 2010 being further configured to display, based on a component position of the virtual component in the virtual scene in response to the selection operation, at least one adjustment control having an accompanying association relationship with the virtual component, the accompanying association relationship being configured for representing a relationship in which the at least one adjustment control changes with a change in the component position, and the adjustment control being configured for adjusting a display status of the virtual component in the virtual scene.

In an embodiment, the display module 2010 is further configured to display, in a preset region range corresponding to the component position, the at least one adjustment control having the accompanying association relationship with the virtual component.

In an embodiment, the display module 2010 is further configured to display, in the preset region range corresponding to the component position and by using the virtual component as a center, the at least one adjustment control distributed according to a preset control distribution rule, the accompanying association relationship existing between the at least one adjustment control and the virtual component.

In an embodiment, the display module 2010 is further configured to display a circular region having the accompanying association relationship with the virtual component; and display, on a circular contour corresponding to the circular region, the at least one adjustment control having the accompanying association relationship with the virtual component.

In an embodiment, the display module 2010 is further configured to display a circular region that uses a component center of the virtual component as a circle center and a preset length as a radius.

In an embodiment, the display module 2010 is further configured to: in response to an adjustment operation on the component position, display the virtual component whose component position is adjusted, and an animation in which the at least one adjustment control changes with a change in the component position.

In an embodiment, the at least one adjustment control includes a movement control, and the movement control is configured for adjusting the component position of the virtual component in the virtual scene.

The display module 2010 is further configured to receive a first trigger operation on the movement control, the first trigger operation being configured for moving the virtual component from a first position to a second position in the virtual scene; and during display of a movement animation in which the virtual component is moved from the first position to the second position, display, based on the accompanying association relationship between the virtual component and the at least one adjustment control in response to the first trigger operation, a movement following animation in which the at least one adjustment control follows movement of the virtual component.

In an embodiment, the display module 2010 is further configured to display, based on the accompanying association relationship between the virtual component and the at least one adjustment control, the movement following animation in which the at least one adjustment control follows movement of the virtual component from the first position to the second position.

In an embodiment, the at least one adjustment control includes a size adjustment control, and the size adjustment control is configured for adjusting a component size of the virtual component in the virtual scene.

The display module 2010 is further configured to receive a second trigger operation on the size adjustment control, the second trigger operation being configured for adjusting the virtual component from a first component size to a second component size, and the virtual component including a first component reference point used as reference information in a component size adjustment process; and during display of a size adjustment animation in which the virtual component is adjusted from the first component size to the second component size, display, based on the accompanying association relationship between the virtual component and the at least one adjustment control in response to the second trigger operation, a first accompanying animation in which the at least one adjustment control moves along with the first component reference point.

In an embodiment, the at least one adjustment control includes an angle adjustment control, and the angle adjustment control is configured for adjusting a display angle of the virtual component relative to the virtual scene.

The display module 2010 is further configured to receive a third trigger operation on the angle adjustment control, the third trigger operation being configured for adjusting the virtual component from a first rotation angle to a second rotation angle, and the virtual component including a second component reference point used as reference information in a rotation angle adjustment process; and during display of a component rotation animation in which the virtual component is adjusted from the first rotation angle to the second rotation angle, display, based on the accompanying association relationship between the virtual component and the at least one adjustment control in response to the third trigger operation, a second accompanying animation in which the at least one adjustment control moves along with the second component reference point.

In an embodiment, the at least one adjustment control includes a function expansion control, and the function expansion control is configured for expanding and displaying another function control.

The display module 2010 is further configured to receive a fourth trigger operation on the function expansion control, the fourth trigger operation being configured for expanding and displaying the another function control; and display a function control list in response to the fourth trigger operation, the function control list including the another function control.

In an embodiment, the display module 2010 is further configured to display a component coordinate system, the component coordinate system being a coordinate system established based on the component position of the virtual component in the virtual scene.

In an embodiment, the component coordinate system includes at least two coordinate axes, and the at least two coordinate axes include a first coordinate axis.

The display module 2010 is further configured to receive a coordinate axis trigger operation on the first coordinate axis, the coordinate axis trigger operation being configured for moving the virtual component along a direction of the first coordinate axis; and display, based on the coordinate axis trigger operation, a component movement animation in which the virtual component is moved along the first coordinate axis.

In an embodiment, the display module 2010 is further configured to hide the component coordinate system and the at least one adjustment control based on the coordinate axis trigger operation; and display the component movement animation in which the virtual component is moved along the hidden first coordinate axis.

In an embodiment, the display module 2010 is further configured to display, based on the component position of the virtual component in the virtual scene, a component adjustment region having an accompanying association relationship with the virtual component, where the component adjustment region is configured for displaying the at least one adjustment control.

In an embodiment, the component adjustment region includes a region movement control, where the region movement control is configured for independently moving the component adjustment region.

The display module 2010 is further configured to receive a control trigger operation on the region movement control, and display a region movement animation in which the component adjustment region is moved in the virtual scene.

In an embodiment, the display module 2010 is further configured to display prompt information based on the accompanying association relationship between the virtual component and the component adjustment region in response to that the control trigger operation indicates to move the component adjustment region out of a preset movement range corresponding to the virtual component, the prompt information being configured for prompting to move the component adjustment region in the preset movement range.

In an embodiment, the display module 2010 is further configured to display, based on a component type of the virtual component by using the accompanying association relationship, an adjustment control corresponding to the component type as the at least one adjustment control, different component types respectively corresponding to at least one adjustment control.

To sum up, the position at which the at least one adjustment control is displayed is closer to the component position of the virtual component. This is beneficial for a player to view the adjustment control during observation of the virtual component. In addition, the adjustment control is configured for adjusting the display status of the virtual component in the virtual scene. Therefore, a process of adjusting the virtual component more efficiently can be implemented by using the at least one adjustment control that is displayed more closely to the virtual component, thereby avoiding a problem of relatively low adjustment efficiency caused by fixedly displaying the adjustment control in the virtual scene, and improving human-computer interaction efficiency by virtue of a display effect of the accompanying association relationship.

The virtual component configuration apparatus provided in the foregoing embodiment is described only with an example of division of the foregoing function modules. In practical applications, the foregoing functions may be allocated to and completed by different function modules according to requirements. That is, the internal structure of the apparatus is divided into different function modules to complete all or some of the functions described above. In addition, the virtual component configuration apparatus and the virtual component configuration method provided in the foregoing embodiments belong to the same conception. For the implementation process, refer to the method embodiments. Details are not described herein again.

FIG. 21 is a block diagram of a structure of an electronic device 2100 according to an embodiment of this disclosure. The electronic device 2100 may be a portable mobile terminal, such as a smartphone, an in-vehicle terminal, a tablet computer, a moving picture experts group audio layer III (MP3) player, a moving picture experts group audio layer IV (MP4) player, a notebook computer, or a desktop computer. The electronic device 2100 may alternatively be referred to as another name such as user equipment, a portable terminal, a laptop terminal, or a desktop terminal.

Generally, the electronic device 2100 includes a processor 2101 and a memory 2102.

The processor 2101 may include one or more processing cores, for example, a 4-core processor or an 8-core processor. The processor 2101 may be implemented in at least one hardware form of a digital signal processor (DSP), a field-programmable gate array (FPGA), and a programmable logic array (PLA). The processor 2101 may alternatively include a main processor and a coprocessor. The main processor is configured to process data in an active state, and is alternatively referred to as a central processing unit (CPU). The coprocessor is a low-power processor configured to process data in a standby state. In some embodiments, the controller 2101 may be integrated with a graphics processing unit (GPU). The GPU is configured to render and draw content that needs to be displayed on a display screen. In some embodiments, the processor 2101 may further include an artificial intelligence (AI) processor. The AI processor is configured to process computing operations related to machine learning.

The memory 2102 may include one or more computer-readable storage media. The computer-readable storage medium may be non-transient. The memory 2102 may further include a high-speed random access memory and a nonvolatile memory, for example, one or more disk storage devices or flash storage devices. In some embodiments, the non-transient computer-readable storage medium in the memory 2102 is configured for storing a computer program, and the computer program is configured for being run by the processor 2101 to implement the virtual component configuration method provided in the method embodiments of this disclosure.

In some embodiments, the electronic device 2100 further includes one or more sensors. The one or more sensors include, but are not limited to, a proximity sensor, a gyroscope sensor, and a pressure sensor.

The proximity sensor, alternatively referred to as a distance sensor, is usually disposed on a front panel of the electronic device 2100. The proximity sensor is configured to collect a distance between a user and a front surface of the electronic device 2100.

The gyroscope sensor may detect a body direction and a rotation angle of the electronic device 2100. The gyroscope sensor may cooperate with an acceleration sensor to collect a 3D action by the user on the electronic device 2100. The processor 2101 may implement the following functions based on data collected by the gyroscope sensor: action sensing (such as changing a UI based on a tilt operation of the user), image stabilization during shooting, game control, and inertial navigation.

The pressure sensor may be disposed on a side frame of the electronic device 2100 and/or a lower layer of the display screen. When the pressure sensor is disposed on the side frame of the electronic device 2100, a holding signal of the user on the electronic device 2100 may be detected, and the processor 2101 may perform left/right hand identification or a quick operation based on the holding signal collected by the pressure sensor. When the pressure sensor is disposed on the lower layer of the display screen, the processor 2101 controls, through a pressure operation of the user on the display screen, an operable control in an interface of the UI. The operable control includes at least one of a button control, a scroll-bar control, an icon control, and a menu control.

In some embodiments, the electronic device 2100 further includes other component parts. It is noted that the structure shown in FIG. 21 constitutes no limitation on the electronic device 2100, and the electronic device may include more or fewer components than those shown in the figure, or some components may be combined, or a different component deployment may be used.

An embodiment of this disclosure further provides a computer device. The computer device may be implemented as the terminal or the server shown in FIG. 2. The computer device includes a processor and a memory. The memory has a computer program stored therein. The computer program is loaded and executed by the processor to implement the virtual component configuration method provided in the foregoing method embodiments.

An embodiment of this disclosure further provides a computer-readable storage medium, the computer-readable storage medium having a computer program stored herein, and the computer program being loaded and executed by a processor to implement the virtual component configuration method provided in the foregoing method embodiments.

An embodiment of this disclosure further provides a computer program product, including a computer program, the computer program being stored in a computer-readable storage medium. A processor of a computer device reads computer instructions from the computer-readable storage medium and executes the computer instructions to cause the computer device to perform the virtual component configuration method according to any one of the foregoing embodiments.

In one embodiment, the computer-readable storage medium may include a read-only memory (ROM), a random access memory (RAM), a solid state drive (SSD), an optical disc, or the like. The random access memory may include a resistance random access memory (ReRAM) and a dynamic random access memory (DRAM). The sequence numbers of the foregoing embodiments of this disclosure are merely for description purpose but do not imply the preference among the embodiments.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely embodiments of this disclosure, but are not intended to limit this disclosure. Any modification, equivalent replacement, or improvement made within the spirit and principle of this disclosure shall fall within the protection scope of this disclosure.

What is claimed is:

1. A method of virtual component configuration, the method comprising:
displaying a virtual component in a virtual scene;
receiving a selection operation on the virtual component; and
displaying, in response to the selection operation, one or more adjustment controls of the virtual component based on a component position of the virtual component in the virtual scene, the one or more adjustment controls being displayed with an accompanying association relationship with the virtual component, the accompanying association relationship causing the displaying of the one or more adjustment controls to change with a change in the component position of the virtual component, and the one or more adjustment controls being used to adjust a display status of the virtual component in the virtual scene.

2. The method according to claim 1, wherein the displaying the one or more adjustment controls comprises:
displaying, in a preset region range of the component position, the one or more adjustment controls having the accompanying association relationship with the virtual component.

3. The method according to claim 2, wherein the displaying the one or more adjustment controls comprises:
displaying, with the virtual component being a center, the one or more adjustment controls in the preset region range according to a preset control distribution rule.

4. The method according to claim 1, wherein the displaying the one or more adjustment controls comprises:
displaying a circular region that is centered at a component center of the virtual component and has a radius of a preset length; and
displaying, on a circular contour of the circular region, the one or more adjustment controls having the accompanying association relationship with the virtual component.

5. The method according to claim 1, further comprising:
in response to an adjustment operation on the component position of the virtual component,
displaying the virtual component with the component position being adjusted with a first change, and
displaying an animation of the one or more adjustment controls, the animation representing the displaying of the one or more adjustment controls changing with the first change in the component position.

6. The method according to claim 5, wherein:
the one or more adjustment controls comprise a movement control that is used to adjust the component position of the virtual component in the virtual scene; and
the method further comprises:
receiving a first trigger operation on the movement control, the first trigger operation causing the virtual component to move from a first position to a second position in the virtual scene;
displaying a movement animation of the virtual component that has a movement from the first position to the second position, and
displaying, based on the accompanying association relationship, a movement following animation of the one or more adjustment controls that follows the movement of the virtual component.

7. The method according to claim 5, wherein:
the one or more adjustment controls comprise a size adjustment control that is used to adjust a component size of the virtual component in the virtual scene; and
the method further comprises:
receiving a second trigger operation on the size adjustment control, the second trigger operation causing the virtual component to change from a first component size to a second component size, and the virtual component comprising a first component reference point as a reference for adjusting the component size;
displaying a size adjustment animation of the virtual component that has a component size adjustment from the first component size to the second component size; and
displaying, based on the accompanying association relationship, a first accompanying animation of the one or more adjustment controls moving along with the first component reference point.

8. The method according to claim 5, wherein:
the one or more adjustment controls comprise an angle adjustment control that is used to adjust a display angle of the virtual component relative to the virtual scene; and
the method further comprises:
receiving a third trigger operation on the angle adjustment control, the third trigger operation causing the virtual component to rotate from a first rotation angle to a second rotation angle, and the virtual component comprising a second component reference point as a reference for rotating the virtual component;
displaying a component rotation animation of the virtual component rotating from the first rotation angle to the second rotation angle, and
displaying, based on the accompanying association relationship, a second accompanying animation of the one or more adjustment controls moving along with the second component reference point.

9. The method according to claim 1, wherein:
the one or more adjustment controls comprises a function expansion control that is used to expand and display additional function controls; and
the method further comprises:
receiving a fourth trigger operation on the function expansion control; and
displaying a function control list in response to the fourth trigger operation, the function control list comprising the additional function controls.

10. The method according to claim 1, wherein the displaying the one or more adjustment controls comprises:
displaying, based on historical adjustment data, the one or more adjustment controls having the accompanying association relationship with the virtual component, the historical adjustment data indicating triggering history of a plurality of adjustment controls within a historical time period, and the one or more adjustment controls being filtered out from the plurality of adjustment controls based on the historical adjustment data.

11. The method according to claim 1, the method further comprising:
displaying a component coordinate system that is established based on the component position of the virtual component in the virtual scene.

12. The method according to claim 11, wherein:
the component coordinate system comprises at least two coordinate axes, and the at least two coordinate axes comprise a first coordinate axis; and
the method further comprises:
receiving a coordinate axis trigger operation on the first coordinate axis, the coordinate axis trigger operation causing the virtual component to move along a direction of the first coordinate axis; and
displaying, based on the coordinate axis trigger operation, a component movement animation of the virtual component moving along the first coordinate axis.

13. The method according to claim 12, wherein the displaying the component movement animation comprises:
hiding the component coordinate system and the one or more adjustment controls in response to the coordinate axis trigger operation; and
displaying the component movement animation of the virtual component moving along the first coordinate axis that is hidden.

14. The method according to claim 1, wherein the displaying the one or more adjustment controls comprises:
displaying, based on the component position of the virtual component in the virtual scene, a component adjustment region that has the accompanying association relationship with the virtual component, the component adjustment region being used for displaying the one or more adjustment controls.

15. The method according to claim 14, wherein:
the component adjustment region comprises a region movement control that is used for independently moving the component adjustment region; and
the method further comprises:
receiving a control trigger operation on the region movement control, and
displaying a region movement animation of the component adjustment region moving in the virtual scene.

16. The method according to claim 15, wherein:
the method further comprises:
displaying prompt information when the control trigger operation indicates to move the component adjustment region out of a preset movement range of the virtual component, and the prompt information being used to prompt to move the component adjustment region into the preset movement range.

17. The method according to claim 1, wherein the displaying the one or more adjustment controls comprises:
displaying, based on a component type of the virtual component, the one or more adjustment controls associated with the component type, and different component types being respectively associated with different one or more adjustment controls.

18. An information processing apparatus, comprising processing circuitry configured to:
display a virtual component in a virtual scene;
receive a selection operation on the virtual component; and
display, in response to the selection operation, one or more adjustment controls of the virtual component based on a component position of the virtual component in the virtual scene, the one or more adjustment controls being displayed with an accompanying association relationship with the virtual component, the accompanying association relationship causing the displaying of the one or more adjustment controls to change with a change in the component position of the virtual component, and the one or more adjustment controls being used to adjust a display status of the virtual component in the virtual scene.

19. The information processing apparatus according to claim 18, wherein the processing circuitry is configured to:
in response to an adjustment operation on the component position of the virtual component,
display the virtual component with the component position being adjusted with a first change, and
display an animation of the one or more adjustment controls, the animation representing the displaying of the one or more adjustment controls changing with the first change in the component position.

20. A non-transitory computer-readable storage medium storing instructions which when executed by at least one processor cause the at least one processor to perform:
displaying a virtual component in a virtual scene;
receiving a selection operation on the virtual component; and
displaying, in response to the selection operation, one or more adjustment controls of the virtual component based on a component position of the virtual component in the virtual scene, the one or more adjustment controls being displayed with an accompanying association relationship with the virtual component, the accompanying association relationship causing the displaying of the one or more adjustment controls to change with a change in the component position of the virtual component, and the one or more adjustment controls being used to adjust a display status of the virtual component in the virtual scene.
